(19) United States
(12) Patent Application Publication
(10) Pub. No.: US 2023/0277404 A1
(43) Pub. Date: Sep. 7, 2023

(54) SYSTEM AND METHOD FOR GUIDING VISUALLY IMPAIRED PERSON FOR WALKING USING 3D SOUND POINT

(71) Applicant: SAMSUNG ELECTRONICS Co., LTD., Suwon-si (KR)

(72) Inventors: Moehammad Dzaky Fauzan MA'AS, Jakarta (ID); Muhamad Iqba IPENI, Jakarta (ID); Irham FAUZAN, Jakarta (ID); Damar Widyasmoro HUTOYO, Jakarta (ID)

(73) Assignee: SAMSUNG ELECTRONICS Co., LTD., Suwon-si (KR)

(21) Appl. No.: 18/198,057

(22) Filed: May 16, 2023

Related U.S. Application Data
(63) Continuation of application No. PCT/KP2022/021191, filed on Dec. 23, 2022.

(30) Foreign Application Priority Data
Dec. 23, 2021 (ID) P00202111998

(51) Int. Cl. A61H 3/06

(52) U.S. Cl. CPC A61H 3/061; A61H 2003/063; A61H 2201/5048; A61H 2201/5058

(57) ABSTRACT

Herein disclosed a system and method of an intelligent visually impaired guiding system to help visually impaired people navigate easily when walking. The purpose of this invention is to create method, system, and apparatus, which assist the navigation of visually impaired people when walking, by following the trajectory path constructed by the system based on real-time environment condition. The invention provides an intelligent method of 3D sound point generation by utilizing the natural ability of humans to localize sounds. Therefore, this invention will eliminate biased information when navigating and increase the level of independence of visually impaired people.

### CROSS REFERENCE TO RELATED APPLICATION(S)

This application is a bypass continuation of International Application No. PCT/KR2022/021191, filed on Dec. 23, 2022, which is based on and claims priority to Indonesia Patent Application No. P00202111998, filed on Dec. 23, 2021, in the Indonesia Intellectual Property Office, the disclosures of which are incorporated by reference herein in their entireties.

### BACKGROUND

### 1. Field

The present invention relates generally to a system and method to assist the navigation of visually impaired people when walking by using an apparatus to create a trajectory path that is constructed based on real-time environmental conditions. The invention provides an intelligent method of 3D sound point generation by utilizing the natural ability of humans to localize sounds. Therefore, this invention will eliminate biased information when navigating and increase the level of independence of visually impaired people.

### 2. Description of the Related Art

According to the World Health Organization (WHO), there are at least 2.2 billion people having a form of vision impairment, and about half of these cases were untreatable or cannot be addressed. Blind and visually impaired people encountered many of challenges when performing many normal activities, such as detecting static or dynamic objects and safely navigating through their paths from home to someplace else. The level of difficulty increases when the environment is unknown and could present a dangerous situation for visually impaired people. This situation often requires assistance from others, or the visually-impaired person will use the same route every time by remembering unique elements in the surrounding environment.

There has been an increasing recognition of the importance and benefits to society of social inclusion and the full participation of disabled people. Several systems were designed to improve the quality of life of visually impaired people and support their mobility, such as the enactment of legislation aimed to remove discrimination against disabled people, disability-friendly public facilities improvement, a community that supports the activities of people with disabilities, and the development of assistive technology.

Most of today’s common assistive technologies for guiding visually impaired people use speech instruction, which can provide biased information while navigating. The use of third party assistance is also common, such as remote operators or trained pets. However, this can reduce a visually-impaired person’s level of independence.

Several studies have found that visually impaired people have improved sensory perception as a result of their visual deficiencies. First, they have more sensitive hearing capability when compared to the Inter-aural Time Differences (ITD) and Inter-aural Level Differences (ILD) of sighted people, even at younger ages. Second, the Ground Reaction Forces (GRF) of visually impaired people are predominantly similar throughout the gait cycle profile when compared to sighted people walking with eyes open and eyes closed. Finally, it has been found that the major characteristics of veering when walking are not caused by the absence of the eyesight.

Additionally, smart glasses have mainly been designed to support microinteractions and continue to be developed since the launch of Google Glass in 2014. Most smart glasses today are equipped with a camera, audio/video capability, and multiple sensors that could be utilized to process information from the surrounding environment.

Therefore, there is a need for technology that provides real-time trajectory path and 3D sound point information to guide visually impaired people by utilizing the natural ability of humans to localize sounds, and in so doing, help the visually impaired to overcome the various physical, social, infrastructural, and accessibility barriers they commonly encounter and live actively, productively, and independently as equal members of society.

### SUMMARY

According to an embodiment of the disclosure, a system for assisting a visually impaired user to navigate a physical environment includes: a camera; a range sensor; a microphone; a sound output device; a memory configured to store at least one instruction; and a processor configured to execute the at least one instruction to: receive an information on the user’s then current position from one or more of the camera, the range sensor, and the microphone, receive an information on a destination from the microphone, generate a first path from the user’s starting position to the destination, and based on the first path, determine in real-time at least one 3D sound point value and position and provide an output to the sound output device, wherein the output to the sound output device comprises 3D a directional sound configured to provide sensory prompts to guide the user as the user moves along the first path.

The processor may be further configured to execute the at least one instruction to: receive an information on the location of an obstacle on the first path from one or more of the camera and the range sensor, and based on the identification of the obstacle on the first path, to alter the first path to avoid the obstacle.

The processor may be further configured to execute the at least one instruction to: receive an information on a moving object within a first range of the user from one or more of the camera and the range finder, determine a probability of the moving object posing a safety risk to the user, and based on the probability of the moving object posing a safety risk to the user exceeding a threshold, generating a waming signal to the user through the sound output device.

The processor may be further configured to execute the at least one instruction to: identify at least one checkpoint along the first path, wherein the at least one checkpoint is located between the user’s then current position and the destination, generate a first checkpoint trajectory between the user’s then current position and the at least one checkpoint, and based on the first checkpoint trajectory, determine in real-time at least one 3D sound point value and position and provide a first checkpoint trajectory output to the sound output device, wherein the first checkpoint trajectory output to the sound output device comprises 3D directional sound configured to provide sensory prompts to guide the user as the user moves along the first path toward the first checkpoint.

The system may also include a GPS receiver, wherein the information on the user’s then current position is received from one or more of the camera, the range sensor, the microphone, and the GPS receiver.

The processor may be further configured to execute the at least one instruction to: receive a real-time update information on the user’s then current position as the user moves along the first path, and provide the real-time update information to a Proportional-Integral-Derivative (PID) controller, wherein the PID controller is configured to determine whether the user has deviated from the first path, and based on a determination that the user has deviated from the first path, to determine in real-time at least one corrective 3D sound point value and position and provide a corrective output to the sound output device, wherein the corrective output to the sound output device comprises 3D directional sound configured to provide sensory prompts to guide the user in a direction that will reduce the difference between the user’s then current position and the first path.

According to another embodiment of the disclosure, a method of assisting a visually impaired user to navigate a physical environment comprising, the method performed by at least one processor, includes: receiving an information on the user’s then current position from one or more of a camera, a range sensor, and a microphone; receiving an information on a destination from a microphone; generating a first path from the user’s starting position to the destination; and based on the first path, determining in real-time at least one 3D sound point value and position and providing an output to the sound output device, wherein the output to the sound output device comprises 3D a directional sound configured to provide sensory prompts to guide the user as the user moves along the first path.

The method may also include: receiving an information on the location of an obstacle on the first path from one or more of the camera and the range sensor, and based on the identification of the obstacle on the first path, altering the first path to avoid the obstacle.

The method may also include: receiving an information on a moving object within a first range of the user from one or more of the camera and the range finder; determining a probability of the moving object posing a safety risk to the user; and based on the probability of the moving object posing a safety risk to the user exceeding a threshold, generating a waming signal to the user through the sound output device.

The method may also include: identifying at least one checkpoint along the first path, wherein the at least one checkpoint is located between the user’s then current position and the destination, generating a first checkpoint trajectory between the user’s then current position and the at least one checkpoint; and based on the first checkpoint trajectory, determining in real-time at least one 3D sound point value and position and providing a first checkpoint trajectory output to the sound output device, wherein the first checkpoint trajectory output to the sound output device comprises 3D directional sound configured to provide sensory prompts to guide the user as the user moves along the first path toward the first checkpoint.

Additionally, the information on the user’s then current position is received from one or more of the camera, the range sensor, the microphone, and a GPS receiver.

The method may also include: receiving a real-time update information on the user’s then current position as the user moves along the first path; and providing the real-time update information to a Proportional-Integral-Derivative (PID) controller, wherein the PID controller is configured to determine whether the user has deviated from the first path, and based on a determination that the user has deviated from the first path, determining in real-time at least one corrective 3D sound point value and position and providing a corrective output to the sound output device, wherein the corrective output to the sound output device comprises 3D directional sound configured to provide sensory prompts to guide the user in a direction that will reduce the difference between the user’s then current position and the first path.

According to another embodiment of the disclosure, a non-transitory computer readable medium having instructions stored therein is provided, wherein the stored instructions are executable by a processor to perform a method of assisting a visually impaired user to navigate a physical environment, the method includes: receiving an information on the user’s then current position from one or more of a camera, a range sensor, and a microphone; receiving an information on a destination from a microphone; generating a first path from the user’s starting position to the destination; and based on the first path, determining in real-time at least one 3D sound point value and position and providing an output to the sound output device, wherein the output to the sound output device comprises 3D a directional sound configured to provide sensory prompts to guide the user as the user moves along the first path.

The non-transitory computer readable medium, wherein the method may also include: receiving an information on the location of an obstacle on the first path from one or more of the camera and the range sensor, and based on the identification of the obstacle on the first path, altering the first path to avoid the obstacle.

The non-transitory computer readable medium, wherein the method may also include: receiving an information on a moving object within a first range of the user from one or more of the camera and the range finder; determining a probability of the moving object posing a safety risk to the user; and based on the probability of the moving object posing a safety risk to the user exceeding a threshold, generating a warning signal to the user through the sound output device.

The non-transitory computer readable medium, wherein the method may also include: identifying at least one checkpoint along the first path, wherein the at least one checkpoint is located between the user’s then current position and the destination, generating a first checkpoint trajectory between the user’s then current position and the at least one checkpoint; and based on the first checkpoint trajectory, determining in real-time at least one 3D sound point value and position and providing a first checkpoint trajectory output to the sound output device, wherein the first checkpoint trajectory output to the sound output device comprises 3D directional sound configured to provide sensory prompts to guide the user as the user moves along the first path toward the first checkpoint.

Additionally, the information on the user’s then current position may be received from one or more of the camera, the range sensor, the microphone, and a GPS receiver. The non-transitory computer readable medium, wherein the method may also include: receiving a real-time update information on the user’s then current position as the user moves along the first path; and providing the real-time update information to a Proportional-Integral-Derivative (PID) controller, wherein the PID controller is configured to determine whether the user has deviated from the first path, and based on a determination that the user has deviated from the first path, determining in real-time at least one corrective 3D sound point value and position and providing a corrective output to the sound output device, wherein the corrective output to the sound output device comprises 3D directional sound configured to provide sensory prompts to guide the user in a direction that will reduce the difference between the user’s then current position and the first path.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram of an Intelligent Visually Impaired Guiding System utilizing Real-time Trajectory Path Generator, Danger Evasion, and 3D Sound Point Generator in accordance with an embodiment of the present disclosure;

FIG. 2 is a diagram of an example pair of smart glasses;

FIG. 3 is a diagram of a Virtual Reality (VR) device;

FIG. 4 is the flow chart of a system in accordance with an embodiment of the present disclosure;

FIG. 5 is an illustration of a sample use case scenario for reading signs and assisting visually impaired person to cross an intersection;

FIG. 6 is an illustration of a sample use case scenario for assisting a visually impaired person to avoid an obstacle when walking;

FIG. 7 is an illustration of a sample use case scenario for assisting a person to find an item on a supermarket shelf;

FIG. 8 is an illustration of a sample use case scenario for providing a warning when crossing a busy street;

FIG. 9 is an illustration of a sample use case scenario for providing a warning when a nearby vehicle is moving backwards toward the person;

FIG. 10 is an illustration of a sample use case scenario for providing a warning when the visibility of oncoming traffic is blocked;

FIG. 11 is an illustration of a sample use case scenario for guiding a user in a new and unknown location;

FIG. 12 is an illustration of a sample use case scenario for danger evasion during cycling when listening to music;

FIG. 13 is an illustration of a sample use case scenario using a VR device for providing live mapping and building information;

FIG. 14 is an illustration of a sample use case scenario using VR device to avoid collision with a person or object in a user’s blind spot;

FIG. 15 is an illustration of a sample use case scenario using VR to guide a user to find an object or location with dot visualization;

FIG. 16 is an illustration of a sample use case scenario using VR to guide a user in a metaverse using 3D sound and display points;

FIG. 17 is graph of Equal-Loudness contours with frequency in Hz;

FIG. 18 is a graph of the relationship between loudness and distance in a 3D adaptive sound diagram;

FIG. 19 is a block diagram of a Intelligent Visually Impaired Guiding System according to an embodiment of the disclosure;

FIG. 20 is block diagram of a Real-time Trajectory Path Generator according to an embodiment of the disclosure;

FIG. 21 is a diagram of an output of a Base Path Generation process according to an embodiment of the disclosure;

FIG. 22 is a diagram of an output of an Object Detection process according to an embodiment of the disclosure;

FIG. 23 is a diagram of an output of an Object Ranging process according to an embodiment of the disclosure;

FIGS. 24A and 24B are diagrams of two ranging areas in accordance with an embodiment of the disclosure;

FIGS. 25A and 25B are diagrams of two more ranging areas in accordance with an embodiment of the disclosure;

FIG. 26 is a diagram of an output of an Object Detection process according to an embodiment of the disclosure;

FIG. 27 is a diagram of an output of a Path Correction process according to an embodiment of the disclosure;

FIG. 28 is a block diagram of Danger Evasion Module according to an embodiment of the disclosure;

FIG. 29 is a block diagram of a Moving Object Detection system according to an embodiment of the disclosure;

FIG. 30 is a diagram showing the field of view of a system according to an embodiment of the disclosure;

FIG. 31 is diagram of a Safe Space Calculation according to an embodiment of the disclosure;

FIG. 32 is a diagram of Vibration Areas for VR devices according to an embodiment of the disclosure;

FIG. 33 is a Truth Table for a Vibrotactile Actuator according to an embodiment of the disclosure;

FIG. 34 is a diagram of a user position determination system according to an embodiment of the disclosure;

FIG. 35 is a block diagram of a 3D Sound Point Generator according to an embodiment of the disclosure;

FIG. 36 is block diagram of a PID Controller according to an embodiment of the disclosure;

FIGS. 37A and 37B are diagrams of a system operating according to a PID controller according to an embodiment of the disclosure;

FIGS. 38A-38D are diagrams of the output of a user guiding process under a normal procedure according to an embodiment of the disclosure;

FIGS. 39A-39F is a diagram of the output of a user guiding process under automatic adjustment when veering according to an embodiment of the disclosure;

FIG. 40 is a block diagram of a process for generating a 3D Display Point according to an embodiment of the disclosure;

FIGS. 41A and 41B are diagrams of ITD and ILD for sound location according to an embodiment of the disclosure;

FIG. 42 is a block diagram of a process of generating a 3D Sound Point according to an embodiment of the disclosure;

FIG. 43 is a diagram of a 3D Sound Point Generator according to an embodiment of the disclosure; and

FIGS. 44A and 44B are diagrams of 3D sound binaural cues using adaptive sound implementation according to an embodiment of the disclosure.

### DETAILED DESCRIPTION

Hereinafter, the present disclosure is described in detail with reference to the accompanying drawings. Reference herein to details of the illustrated embodiments is not intended to limit the scope of the claims.

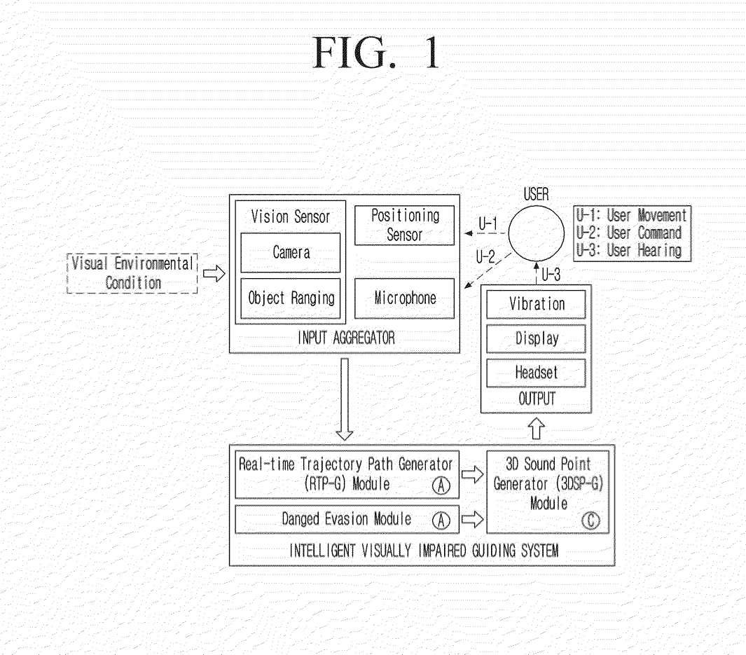

Referring now to FIG. 1, provided is an Intelligent Visually Impaired Guiding System, which hereinafter will be referred to as the Visually Impaired Guiding System (also referred to herein as “VIGS”), in accordance with the present disclosure. As described in FIG. 1, the VIGS includes three main modules. The first module is the input aggregator which has handles communication with the user, determination of the user’s destination, determination of the user’s position, and ascertainment of the environmental situation surrounding the user. The input aggregator may include various sensor components such as a camera, a ranging sensor, a positioning sensor, and a microphone & headset speaker. All of the sensor data will be passed through the information extraction process and combined.

The extracted information is fed to the second module of the VIGS, the Intelligent Visually Impaired Guiding System (hereinafter, the “Intelligent VIGS”), which is the core process of the disclosed system. The main objective of Intelligent VIGS is to determine where, when, and for how long the user must move using a guiding mark in a virtual map with real time path corrections. The Intelligent VIGS includes a Real-time Trajectory Path Generator module, a Danger Evasion module, and a 3D Sound Point Generator module. The Real-time Trajectory Path Generator, hereinafter will be referred as “RTP-G”, simultaneously generates a virtual trajectory path from starting point to destination. The Danger Evasion Module gives a quick waming sign to the user when a potentially dangerous situation is expected to happen. The 3D Sound Point Generator, hereinafter will be referred as “3DSP-G”, will be used to determine and generate 3D sound point position, frequency, and intensity of the guidance sign. The last process is to transmit the output to the headset, display unit, and vibrotactile actuator to cue the user of the direction.

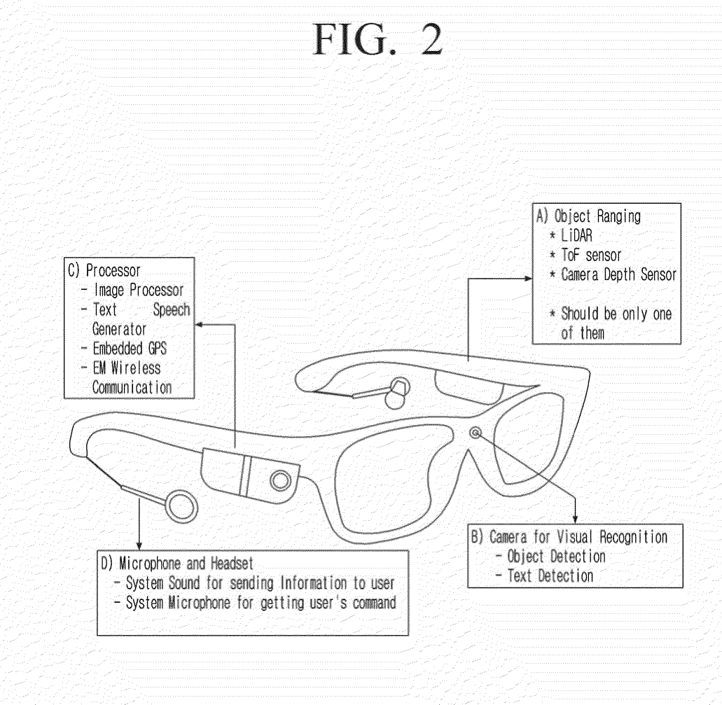

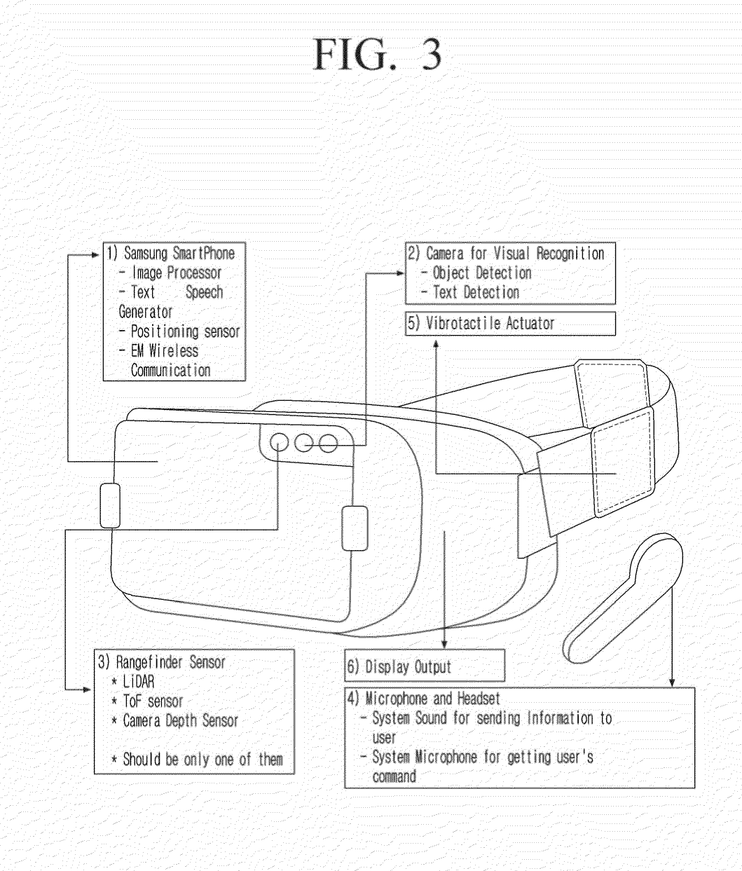

Referring now to FIG. 2 and FIG. 3, the use of smartglasses and VR devices in connection with the present disclosure is described. In the embodiment of FIG. 2, smartglasses can be equipped with 4 components. In an embodiment, the first component is a positioning sensor, such as a basic sensor used to ascertain the user’s position and destination. In an embodiment, a combination of a Global Positioning System (GPS) sensor to detect the position in main map, motion processing unit such as accelerometer and gyroscope, and Ultra Wide Band (UWB) positioning method to get the specific position of the user in indoor and outdoor environments, may be used. In an embodiment, the second component is a camera for visual recognition to replicate the function of human eyes. The camera may be used mainly for object detection and text recognition. In an embodiment, the third component is a ranging sensor to support the visual recognition function of the present disclosure and to enhance the ability of camera to detect objects and measure the distance between the user and the objects. In an embodiment, the ranging sensor may be placed in the front, left, and right sides of the apparatus. In an embodiment, the last component is a microphone and headset to facilitate communication between the user and the system to determine the destination point that the user wants to reach.

As shown in FIG. 3, VR devices may have the same function and elements as the aforementioned apparatus. In an embodiment, there are 2 additional components that can be added to this apparatus. The first is a Vibrotactile Actuator used for creating a sense of physical touch by applying vibration. The actuator may be placed on 4 different sides of the apparatus, ideally in front, back, left and right sides. The second additional component is the display output to show the 3D display view for sighted people.

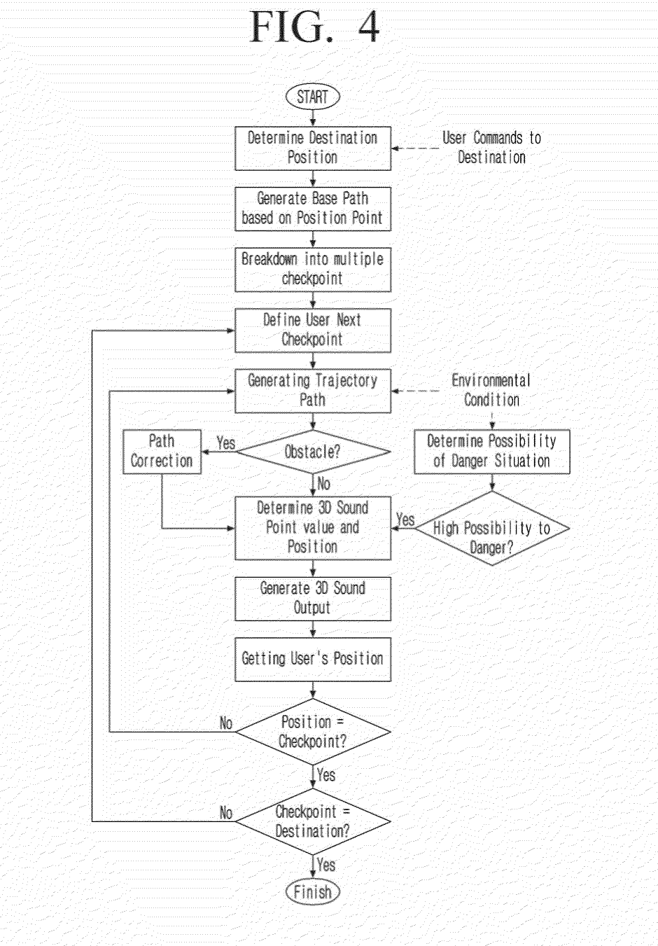

FIG. 4 describes the flow of process for the Visually Impaired Guiding System. To start using the system, the user needs to determine the destination point and give commands by using the microphone on the apparatus to communicate with the system. The system will then generate the base path from the user’s position to the destination point using the positioning sensor, and in so doing will break the path down into multiple checkpoints. Then, the system will determine the user’s next checkpoint and use the RTP-G module to generate a trajectory path for the user. The trajectory path will be updated in real-time when obstacles are found based on the environmental situation. The system will also detect and determine the possibility of a dangerous situation simultaneously using the Danger Evasion module. After that, the system will do a calculation to determine the value and position of the 3D sound point using the 3DSP-G module that the user can sense and follow. As the user follows the sound point, the system will detect the user’s movement and position, and compare it to the checkpoint. When the user arrives at the checkpoint, the system will define the next checkpoint until the final checkpoint of the destination is reached and the process will be finished.

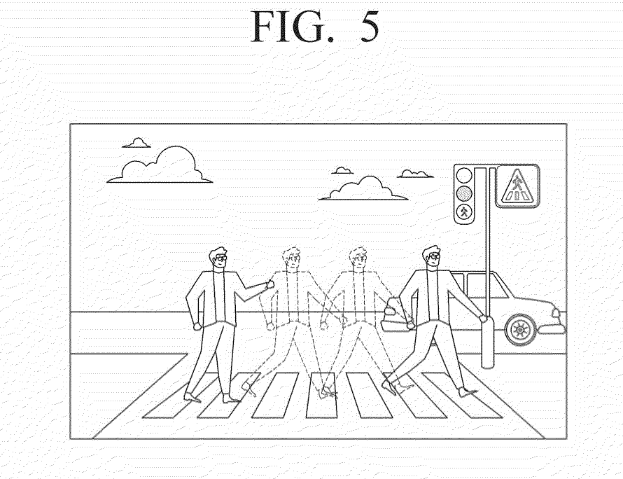

FIG. 5 through FIG. 16 show various example use cases in which the present disclosure may be implemented by utilizing the camera and sensors embedded on the apparatus. As described previously, the camera will collect images of the surrounding environment and combine it with the data received by the sensors on the apparatus.

FIG. 5 shows an example scenario of using the Visually Impaired Guiding System for reading signs and assisting with the navigation of the user when walking. For visually impaired people, walking on the street could be a challenging activity, depending on the environment. For example, it would be difficult to notice the traffic light and signs when they are reaching a crossroad. For sighted people, objects at the front can be reconstructed using the eyes, so they can determine which direction to go and avoid the object when there are obstacles. The eyes also function to identify the color indicator of a traffic light that is currently on. Using the described apparatus, the system will be able to reconstruct the surrounding environment, view and identify the traffic light, and guide the user. The system will read and understand the state of the environment. When the system detects the traffic lights and crossings, it will notify the user to stop walking and move to a safe position to wait for the red light to change to a green light. After the traffic light turns green, the system will guide the user to cross the street using the 3D sound assistant.

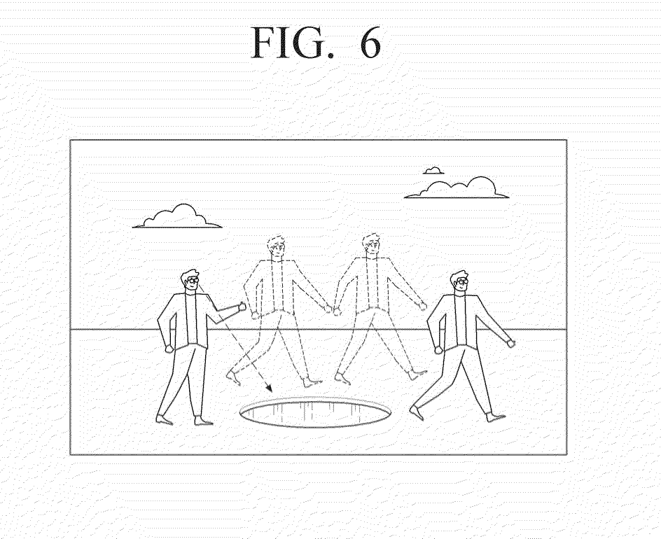

FIG. 6 shows an example scenario of using the Visually Impaired Guiding System to avoid obstacles when walking. The road surface conditions are not always perfect and smooth, as there might be holes and bumps along the way. These can become an obstacle for the visually impaired since they cannot visualize the environmental condition without proper equipment. An apparatus equipped with camera and headset can be used to guide people who have visual impairment. The camera may read and understand the environmental conditions in real time to continue providing guidance so that the visual impaired people stay on track of the path made by the system. This system may also recognize an obstacle in front of them and will regenerate a safer path and avoid the obstacle without changing the destination. The headset may produce 3D sound to guide the users to avoid obstacle in front of them by giving a sound source to the degree that has been calculated to avoid it. If the sound released at 60 degrees on the left, the user can follow the sound source in order to avoid the obstacle.

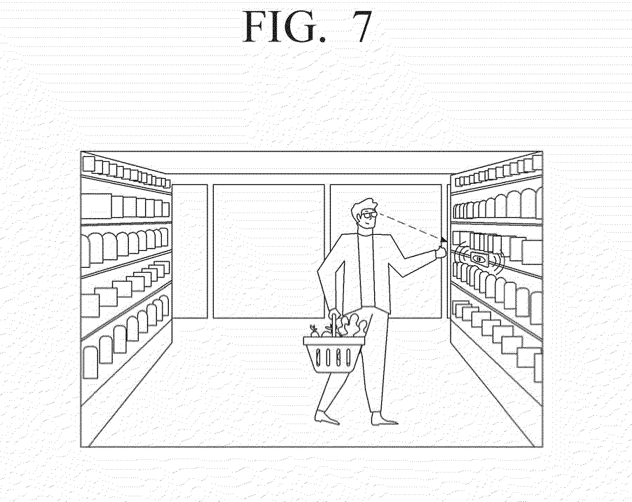

FIG. 7 shows an example scenario of using the Visually Impaired Guiding System to find items on a supermarket shelf. When shopping for groceries, sighted people can easily locate the aisle racks or find the desired item just by looking at the sign and heading to the desired shelves. For visually impaired people, this system can guide them to look for the item they need in supermarkets. When a user enters a supermarket, they can input general voice command to look for the desired item. The system will generate the path based on where the shelves are placed, and generate 3D sound to guide the user. When there is an obstacle, the system will update the path and transmit the 3D sound for the new direction. When the user has reached the targeted area, the system will recognize the item and guide the user to pick up the item. If the intended item is placed on the bottom shelf, the device will produce a 3D sound source downward so that the user knows the position of the item.

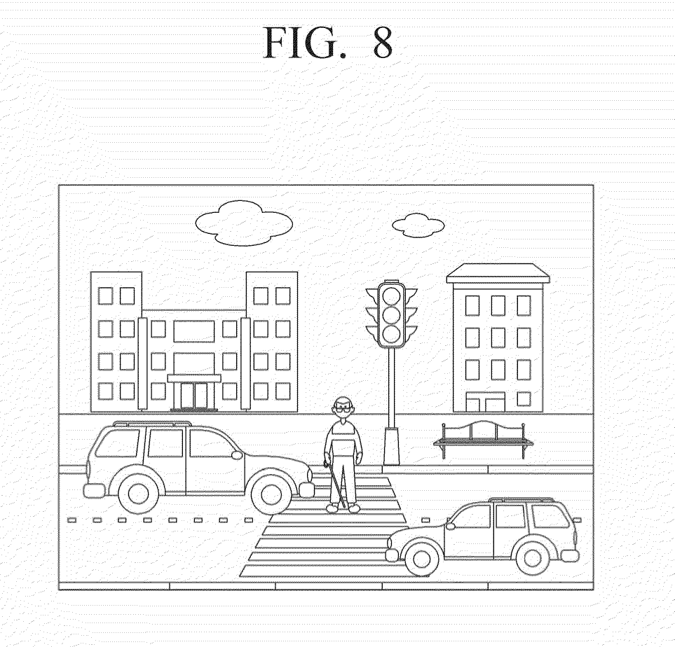

FIG. 8 through FIG. 10 show example scenarios of using the Visually Impaired Guiding System to provide a sudden waming condition. According to certain crash statistics reports, there are an increasing number of pedestrians involved in traffic accidents. Research has confirmed the common-sense proposition that some pedestrians with visual impairments are at an elevated risk level at complex intersections. Based on the American Council of the Blind survey of intersection accessibility by Carroll and Bentzen (1999), it is found that individuals with visual impairments reported difficulty knowing when to begin crossing, traveling straight across wide streets, determining whether there was a push button to activate a pedestrian signal, and determining to which crosswalk a pedestrian signal applied to. Of the 163 respondents, 13 reported that they had been hit by a vehicle and 47 reported that their cane had been run over. There are 3 different scenarios that could happen to pedestrians with visual impairments.

A first scenario is when the pedestrian collides with a moving vehicle when crossing the street. As can be seen on FIG. 8, visually impaired people may have difficulties knowing the right time to cross the street or where to find the push button to activate the crossing signal. The current system has preset safety parameters and some sensors that will detect and track moving objects approaching the visually impaired person (such as vehicles). The preset safety parameters may have two layers set at 11 meters and 7 meters as the safe space. When an object is approaching and enters the first layer, the system will identify the object and calculate the object’s speed, and also track next movement of the object. When an object is enters the second layer and the system detects the object is potentially dangerous, i.e. that it will hit the user, the system will generate 3D sound output as an alert and cue a new direction to avoid the object.

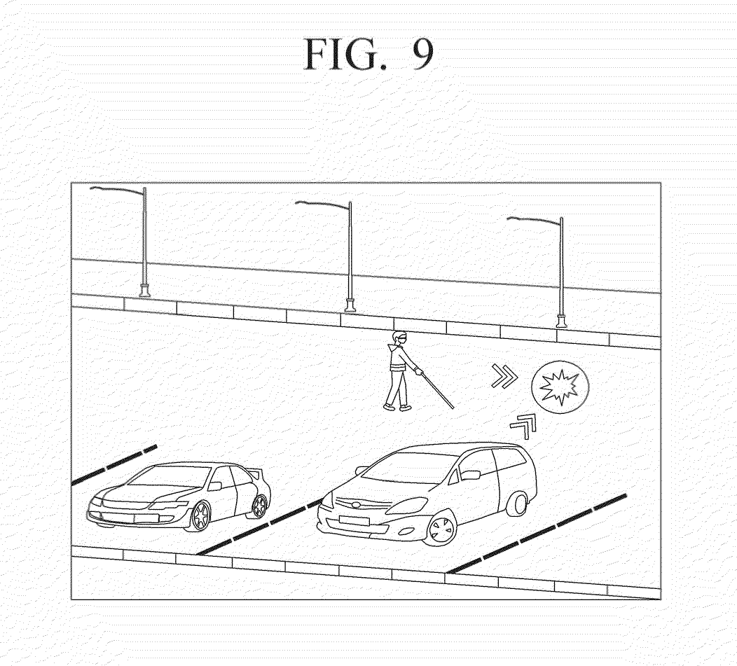

A second scenario is when the pedestrian is passing by a vehicle moving backwards. As can be seen on FIG. 9, this scenario can happen in the driveway, sidewalk, parking lot, and other locations. When in reverse, some drivers might not notice their surroundings and sometimes they drive backwards in a fast manner. When a visually impaired person passes by, the system will automatically scan the surroundings using ranging sensors and the camera at the front to identify the object, calculate the range of the object, and track next movement of the object using the ranging sensor combined with a Recurrent Neural Network (RNN). Since a ranging sensor may use light sensors, it will have high accuracy and fast processing. When the present system detects a vehicle is approaching the user, the 3D Sound Point Generator module and the DE module will generate a 3D sound as an alert and prompt a new direction for the user to move and avoid the vehicle.

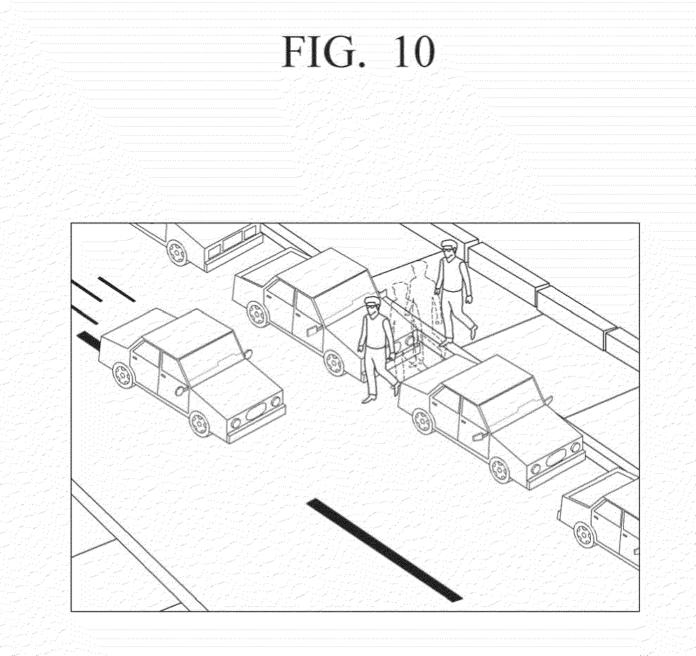

A third scenario is when the visually impaired person is struck by a vehicle because the driver’s visibility is blocked by another object, for example a vehicle parked or stopped on the roadway. As can be seen in FIG. 10, when the user walks on the sidewalk and want to cross the street, sometimes the user needs to walk past several parked vehicles. The system will scan the surrounding environment using ranging sensor and a RNN to calculate the object range and track next movement of the object. The system also has a preset parameter of object speed tolerance that will activate the Danger Evasion module when an approaching object is entering the safe space. The minimum speed is set at 20 km/h or 5.55 m/s. When an object is approaching with faster than the speed limit, the 3DSP-G module will generate 3D sound alert for the user to stop walking because there is a vehicle approaching.

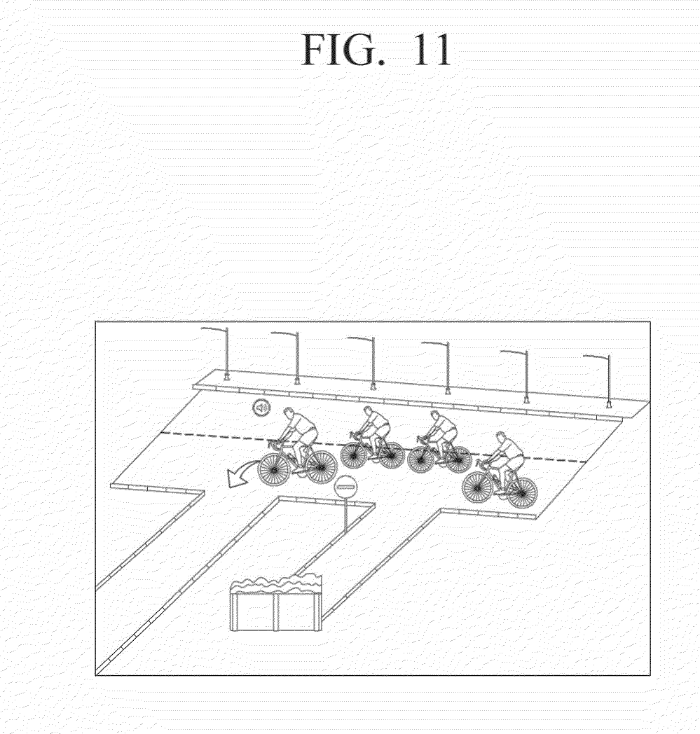

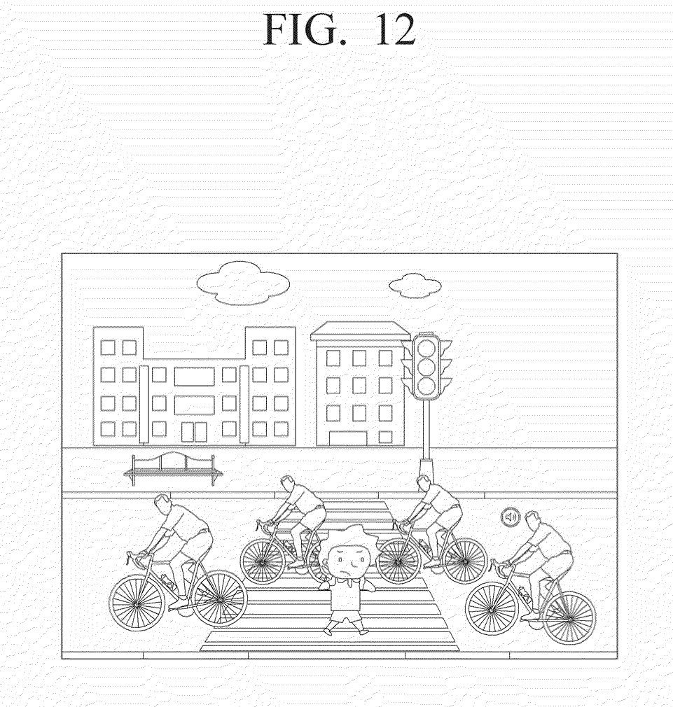

FIG. 11 and FIG. 12 show example scenarios of using the Visually Impaired Guiding System when riding a bicycle. As can be seen in FIG. 11, the present system can be used to assist the user to reach a destination by providing guidance using 3D sound in unfamiliar location. The user can communicate with the system to determine the destination point. The system will then generate the trajectory path to the destination from the user’s current position. After that, the system will guide the user according to results obtained from path generation using 3D sound point guidance to avoid any obstacles so that the user can ride the bicycle safely and be aware of when to turn left or right. Another scenario is to provide danger evasion when listening to music while cycling. As can be seen on FIG. 12, the system can assist the user to make a preventive action to avoid an accident even when the user does not notice the surrounding situation. The user can communicate with the system to determine the destination point. When there is an object that will collide with the user within the safe space zone, the system will turn off the music and alert the user. The system will create 3D sound to guide the user to a safer location and avoid the moving object. After the user reaches the safe location, the system will generate a new path to assist the user back to the correct path.

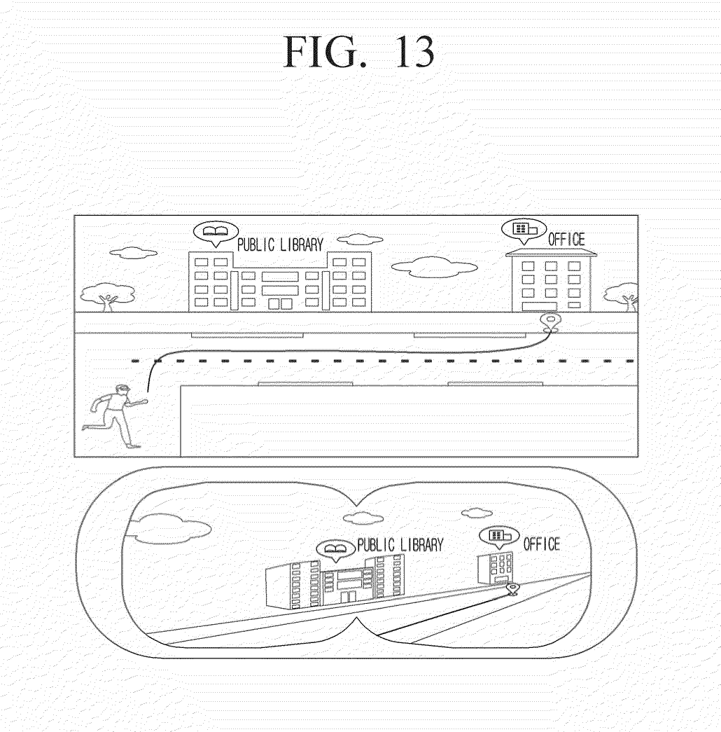

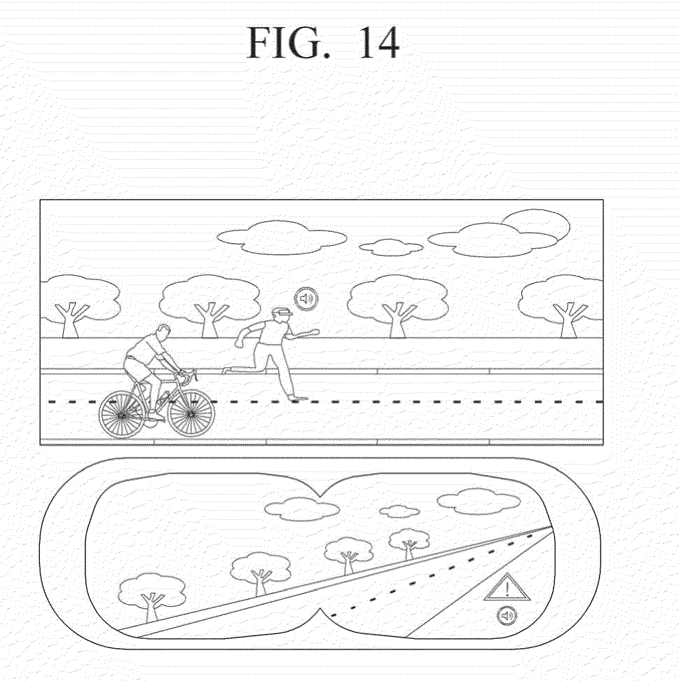

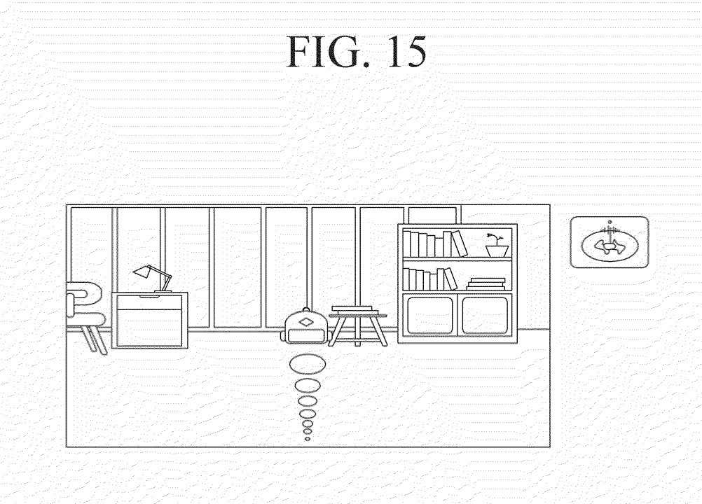

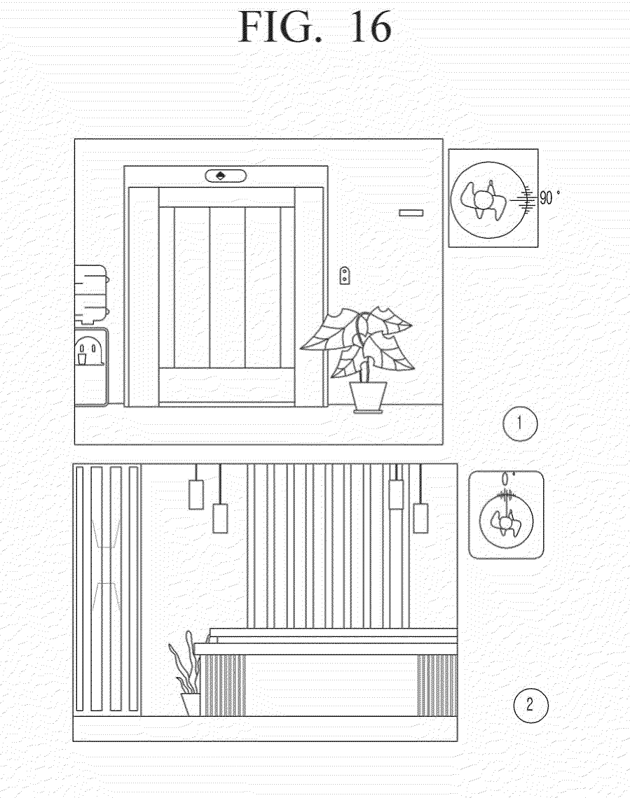

FIG. 13 through FIG. 16 show example scenarios of using the Visually Impaired Guiding System with VR devices. A first scenario involves live mapping, direction and building information. As can be seen on FIG. 13, the system can assist the user by providing directions to the destination point, and also provide information of the environment using object detection, object ranging, and path correction. With both 3D display and sound output during navigation, the user can feel the live navigation and can view the information of the surrounding environment, such as building name. A second scenario involves avoiding collision with objects coming from a user’s blind spot. As can be seen on FIG. 14, the system can give an alert when it detects an incoming object and predicts that it will endanger the user when using VR. When there is a possibility of danger coming to the user from the blind spot, the vibrotactile actuator will vibrate from the direction of the approaching object. The system will also provide 3D Display and Sound point to guide user to safer location. A third scenario is to guide people to find things with dot visualization. As can be seen in FIG. 15, people can use VR to search for objects using the visualization of 3D dots on the display to guide people to find the things. The system will guide the user according to the results of path generation using the guidance of the 3D display and sound points to find the object they are looking for. A fourth scenario is using 3D sound and display point as guidance in VR when the user enters a metaverse. As can be seen in FIG. 16, users can visit an office virtually using VR even though they are currently at their house. Users can communicate with the system to determine the room that the user is looking for. For example, if the user wants to go to the receptionist, the system will generate a trajectory path to the receptionist desk and guide the user using 3D display and sound points. For example, if the receptionist is located on the right side of the user, the 3D Display and Sound output will direct the user to face to the right. The user will be able to explore the office without actually going to the office.

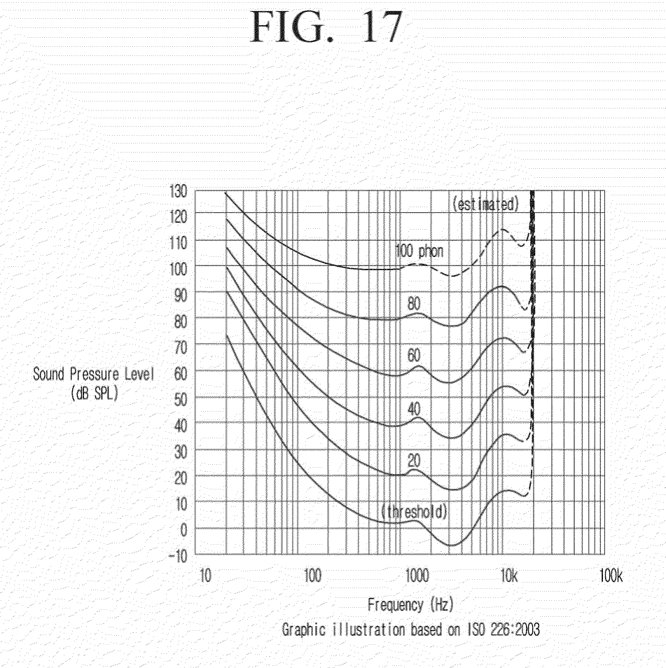

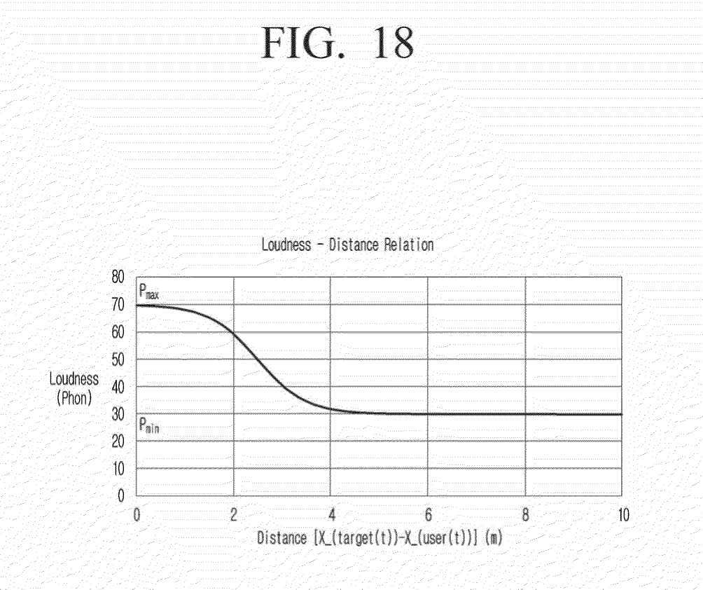

FIG. 17 and FIG. 18 describe the adaptive 3D sound point. The human hearing process is triggered by surrounding sounds in the form of vibration or waves captured by the outer ear. Then, the vibration is forwarded to the ear canal so as to put pressure or blow on the tympanic membrane, or eardrum. When the eardrum trembles, the vibration will be forwarded to the hearing bone and after that the human brain processes the sound to take action. In the location of 3D sound technology, it is referring to sound indoors dimensions of the sound source location, which are usually determined by the direction of the wave or vote angle. Human hearing is based on frequency and decibel (or volume), in which the frequency that can be heard by humans is in the range of 20 - 20.000 Hz, and 0 - 120 dB for its decibel unit. With regard to the present disclosure, the system will use “phon” to represent the size unit of “loudness”. Phon unit will be variable to regulate the level of loudness in the 3D Sound system. Phon calculations can be obtained from decibel settings and frequencies, with restrictions on decibel and frequency. The recommended decibels to be used are 30 - 70 decibels because humans may not be able to hear the sound below 30 decibels and if the decibel is above 70 dB, it will damage the human hearing. The recommended frequency that will be implemented in the system is 3500 - 4000 Hz because this is very sensitive in human hearing according to the CDC.

As can be seen on FIG. 17, the phon value can be calculated from different combinations of frequency and decibel level to provide the same result of phon, based on ISO 226:2003 revision. For example, to get 40 phon requires 63 dB at a frequency of 100 Hz but only 34 dB at 3500 Hz. Based on these examples, to get the equal of the perceived of loudness to human ear is not determined by decibel but based on the phon value. That is the phon calculation is suitable to determine the adaptive sound output for use in the present disclosure.

The 3D sound system will determine the sound point for the user, in which the volume of 3D sound will be higher to hear when the user approaches the checkpoint and reset the volume level when the user reaches the checkpoint. The system will repeat this process until the user reaches the destination. However, when the user moves away from the checkpoint, the volume level will be reset back to the starting level.

FIG. 18 is a graph showing the curve for sound loudness levels where P₍ₜ₎ is the phon value at time t that has a value between Pₘₐₓ and Pₘᵢₙ. The relation between loudness and distance will be implemented in the system using the following equation:

$${P}_{\left(t\right)} = {P}_{m a x} - \left(\frac{\left({P}_{m a x} - {P}_{m i n}\right)}{\left(1 + {\left(e\right)}^{\left(a + b \left({X}_{t a r g e t \left(t\right)} - {X}_{u s e r \left(t\right)}\right)\right)}\right)}\right)$$

Wherein, Pₘₐₓ is the maximum value and Pₘᵢₙ is the minimum value of the loudness of the sound, and t is the time. The position of the user relative to the checkpoint is represented by X_{target} and the position point of the user is represented by Xᵤₛₑᵣ. Then, a and b are constants that control the sigmoid half value intercept and the slope of the graph. Both values need to be found so it can fit with the wanted sigmoid equation using equation solver and it will be unique for its own problem.

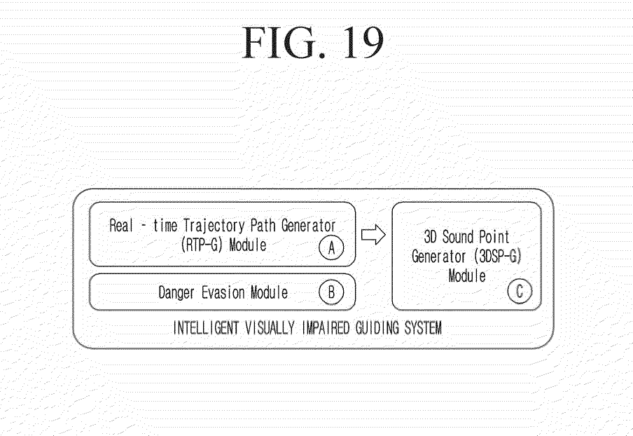

FIG. 19 is a block diagram of the Intelligent Visually Impaired Guiding System. The proposed system consists of multiple modules to assist user using 3D sound to reach the destination. Specifically, the Intelligent Visually Impaired Guiding System combining a Real-Time Trajectory Path Generators (RTP-G) module, a Danger Evasion module, and a 3D Sound Point Generators (3DSP-G) module.

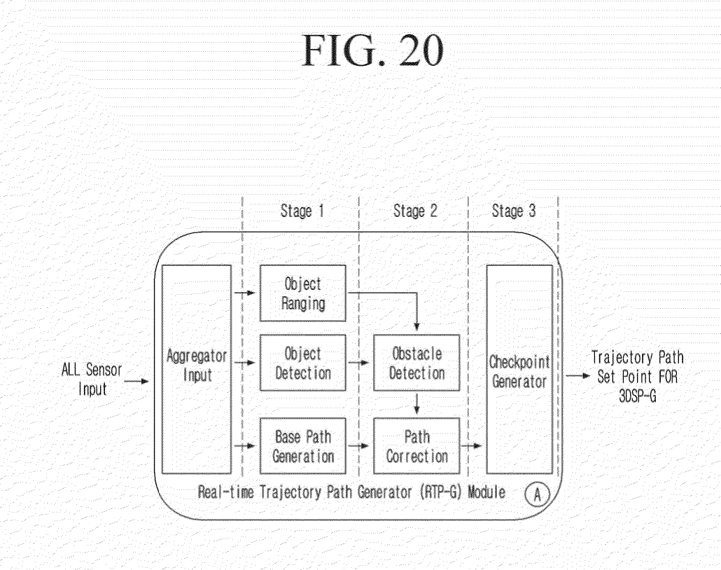

FIG. 20 through FIG. 27 describe the RTP-G module. The RTP-G module is the first process mechanism for the device to be able to guide a person who has visual impairment. As can be seen on FIG. 20, the system requires data from the input aggregator, which will later be processed into 3 groups of stages in order to get the trajectory path. In the first stage group, the input aggregator will provide the data for the Base Path Generation, Object Detection and Object Ranging submodules. Then in the second stage group, the Obstacle Detection and Path Correction submodules will use the data sources from the first stage group. And the third group of stages is the Checkpoint Generator submodule, which is the last process of the entire series to formulate the trajectory path.

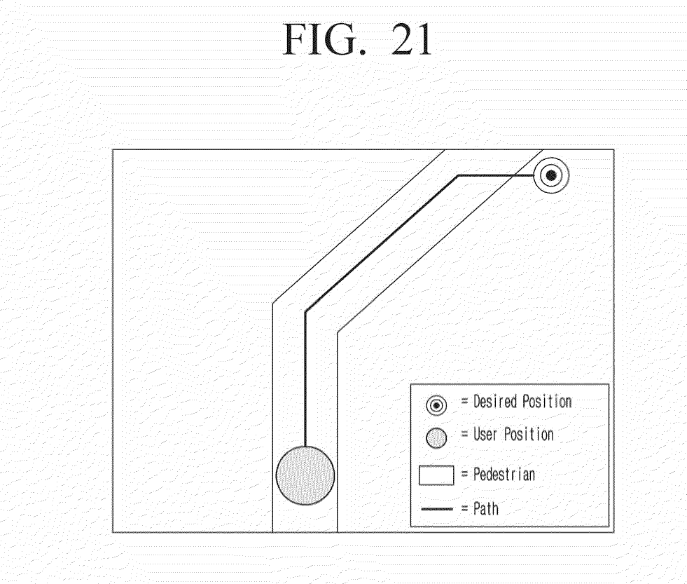

The Base Path Generation submodule is the first step for the system to be able to guide people who have visual impairment. First, the user will give a voice command indicating their destination. Using GPS on the device, the system will pinpoint the user’s current location and calculate the route to the destination location. The system will generate the shortest path to the destination based on user’s current location. As can be seen on FIG. 21, the base path will be calculated and generated based on the walking path which can only be passed through by pedestrians.

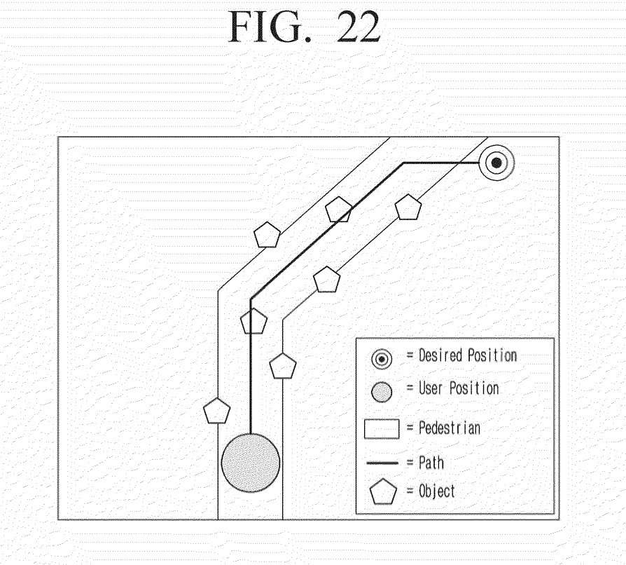

The Object detection submodule is a computer process to recognize objects and find locations where objects are located in the form of images or videos. This submodule will utilize the camera on the user’s device to take visuals in the form of a video. The video represents the actual visualization that occurs in a real situation, so users seem to be able to sense and recognize the surrounding environment. As can be seen on FIG. 22, the camera will continuously scan to detect objects in front of the user so that the system can identify whether or not there is an object on the guide path. When scanning, the system will get three types of information about the object detected, namely the place of the object, the distance between the user and the object, and a determination of whether it is an inanimate object or a moving object. The first information will be used to determine whether the object can be classified as an obstacle or not. The second information will be used to measure how close the object is to the user. The third information will be used to determine if the object is dangerous or not.

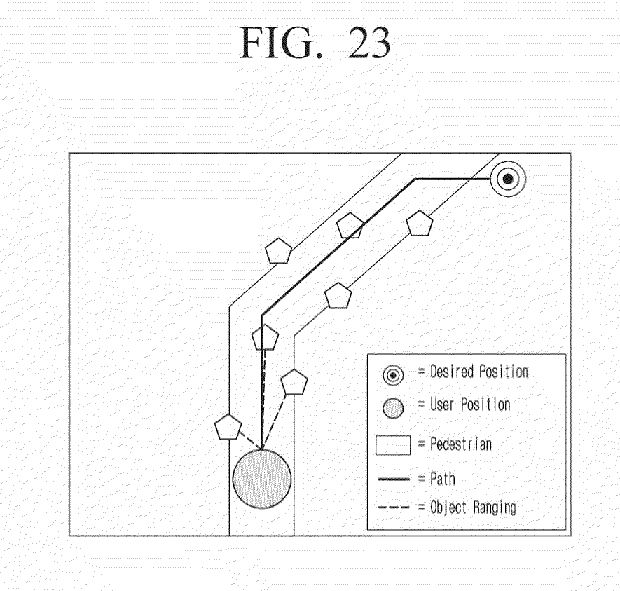

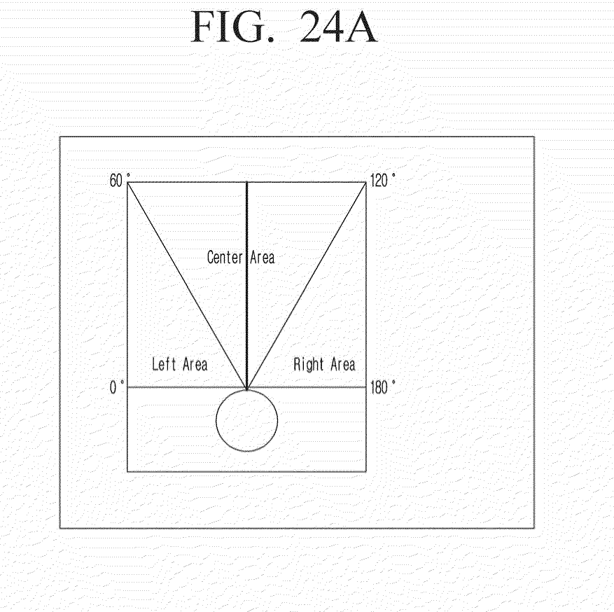

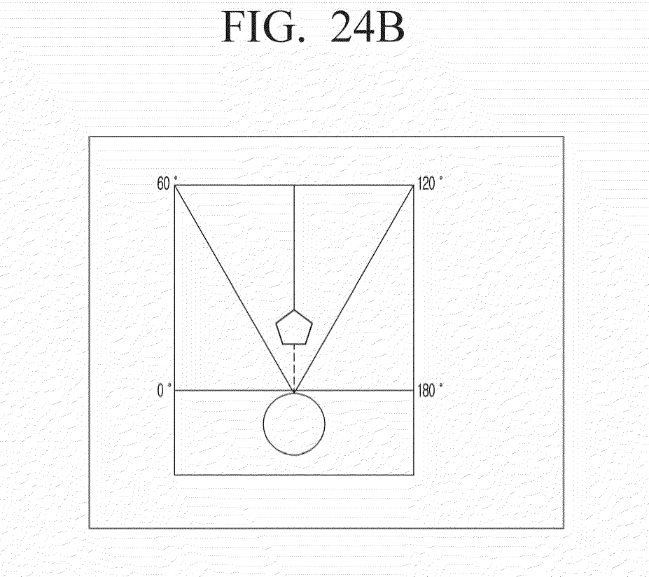

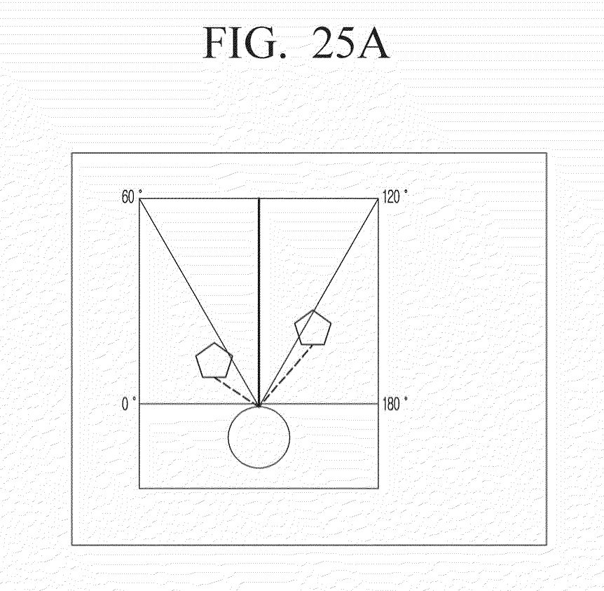

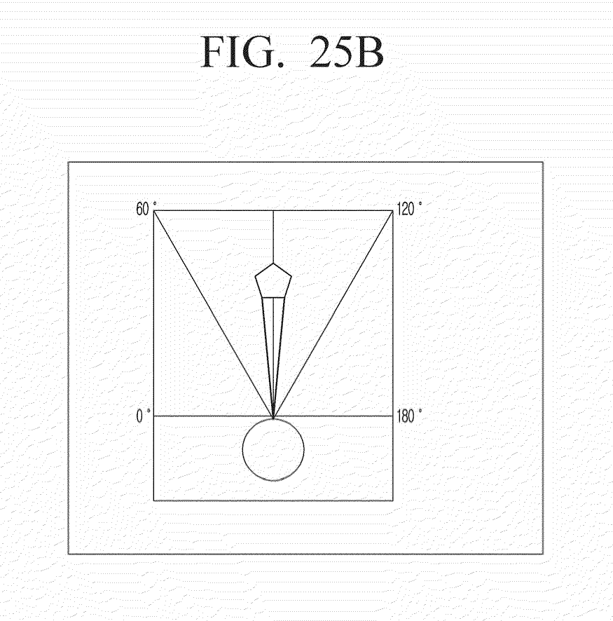

Referring now to FIG. 23, the Object Ranging submodule is an advanced process used by the system to calculate the distance between the user and the objects in front of the user. The known distance will be classified by the system so that the user will get a safe distance information with respect to the existing object in front of the user. To calculate the safe distance between the user and the object, the system will calculate based on the matrix data obtained by the depth sensor. The depth sensor will get coordinate (x, y, z) data, and that coordinate data will be the matrix data and system will be able to calculated the distance. As can be seen in FIGS. 24A and 24B, the system will divide the video frame into three areas to simplify the classification process: left, right, and center. Referring to FIG. 24A, the 3 divided areas will determine the safest area, namely the area that can be passed by the user. In each area, it will detect objects and give a dashed line, dotted line and double line point. The dashed line in FIG. 24B shows that the distance between the user and the object in front of the user is very small, thus the path cannot be passed. Referring now to FIGS. 25A and 25B, the dotted line on FIG. 25A shows that the distance between the user and the object in front of the user is small but the object is not on the previously calculated navigation path. The double line FIG. 25B shows that the object in front of the user is still far away even though it is on the path set by the system so the user can still pass the route.

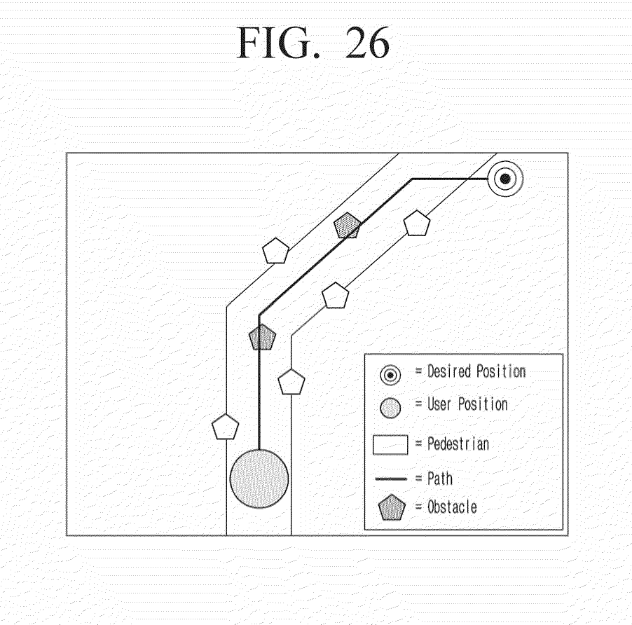

In general, people who have normal vision can easily recognize and avoid any obstacle. Meanwhile, for people who have visual impairment, all objects can be an obstacle that threatens their safety, especially in an environment that is unfamiliar to them. Therefore, the Obstacle Detection submodule is one of the important modules to help people who have visual impairments. The Obstacle Detection submodule is an advanced process of the Object Detection submodule in Stage 1. In this submodule, the camera can recognize an object and the system will analyze whether the object is an obstacle or not. For people who have visual impairment, objects that are blocking the user or located on the base path that has been generated by the system will be included as obstacles. As can be seen on FIG. 26, there are two objects on the base path and they are blocking the user from reaching the destination. When the base path is generated by the system, it will assume that the path is free from any obstacles. However, when there is an object that blocks trajectory path, it will be considered as an obstacle.

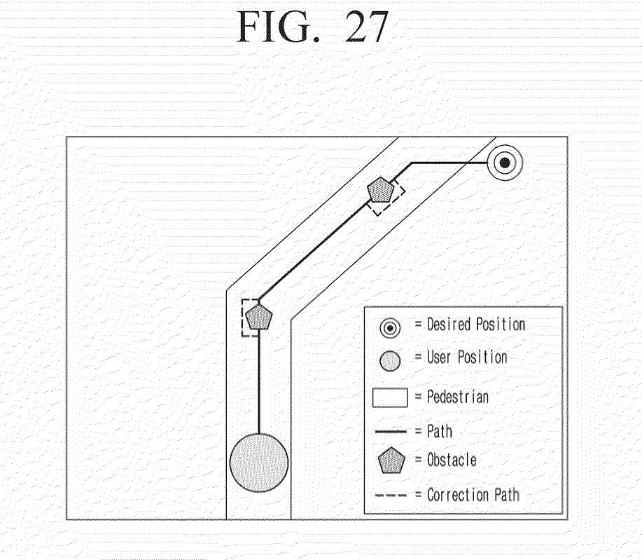

Path Correction is the last submodule that will combine all results from the Stage 1 submodules group. The function of the Path Correction submodule is to create a new path to avoid the obstacles, but the system will make sure that it does not change the final destination. The Path Correction submodule will continue recalculating the route until the user reaches the goal. As can be seen on FIG. 27, the black line is the base path provided by the system for the user to reach the destination. However, the system has identified that there are several obstacles on the base path. The system will recalculate and correct the path for the user using Path Correction submodule, shown using the dashed line. The Path Correction submodule will only alter the path when there are obstacles detected by the system, but the original path to destination will remain the same.

The Checkpoint Generator is the last process for the RTP-G module and has the purpose to determine the user’s next position, which will later become the input for 3D sound Point Generator module to produce a guide sound. Similar to the previous submodules, the Checkpoint Generator will run continuously until the user arrives at the destination. In this submodule, the system will generate a checkpoint every 4 meters from the user’s position to prevent sudden change of user’s walking direction.

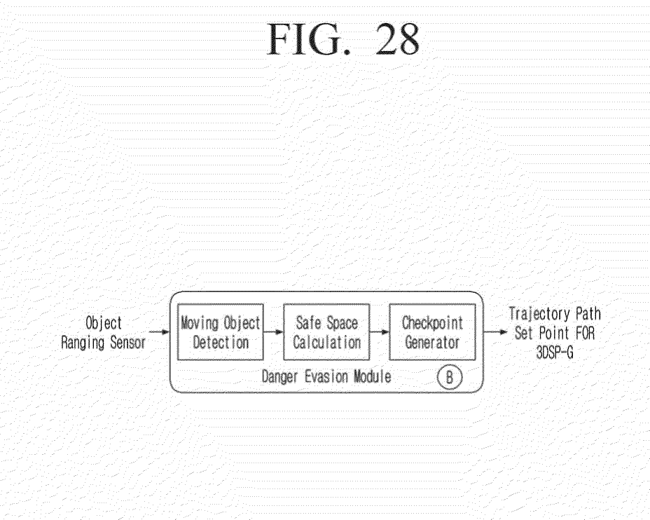

FIG. 28 through FIG. 34 describe the Danger Evasion module. According to natural human perceptions, perceiving a moving object’s movement direction is more important than object detection. When walking, people are more concerned about other people moving and other objects moving towards them rather than detecting and identifying the surrounding objects. An obstacle-free path can change any time a new object or person passes through. Thus, it is important to retrieve information on all objects in the current scene for the system to predict the direction of a moving object with respect to a visually impaired person’s position. The present disclosure may predict dangerous situations for the visually impaired person when walking at pedestrians crossing or on a public street. The Danger Evasion module consists of three submodules, which are the Moving Object Detection (MOD) submodule, the Safe Space Calculation submodule, and the Checkpoint Generator submodule.

As can be seen on FIG. 28, the source of input for the danger evasion module is taken from Object Ranging sensor (e.g., LiDAR). The rangefinder sensor (also referred to herein as a “ranging sensor”) will quickly determine the distance of the object, and the output from Moving Object Detection sensor that is using RNN will determine whether the object is moving or static. The range analysis may use a laser sensor, which consists of a transmitter and a receiver. When the laser sensor (transmitter) emits light toward some objects, it will determine the range of the object by measuring the time for the reflected light to return to the receiver. Using the measured time t (between emitting and receiving the signal) and the known speed of light c (3 × 10⁸ m/s), the distance d between the sensor and the target can be calculated with d = c * t / 2. The advantages of using a laser sensor are high accuracy when measuring the distance and fast processing time because the light sensor fires an average of about 150,000 laser pulses per second.

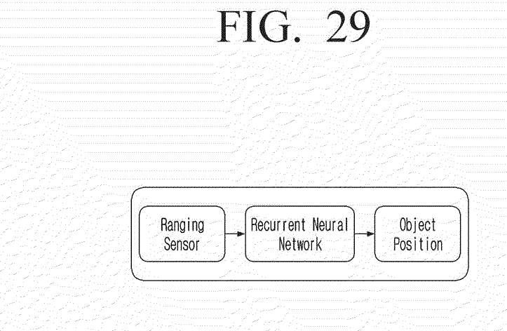

The MOD submodule will use RNN to detect object probability from its movement. As can be seen on FIG. 29, object movements are captured by a series of outputs from ranging sensors. Those series of outputs, which contain information of object locations, are fed into the RNN. The RNN will determine the probability of objects being located in certain locations by analyzing their movement pattern. Every object (e.g. humans, cars, and animals) has a different movement pattern and the RNN will learn to recognize object from its movement pattern.

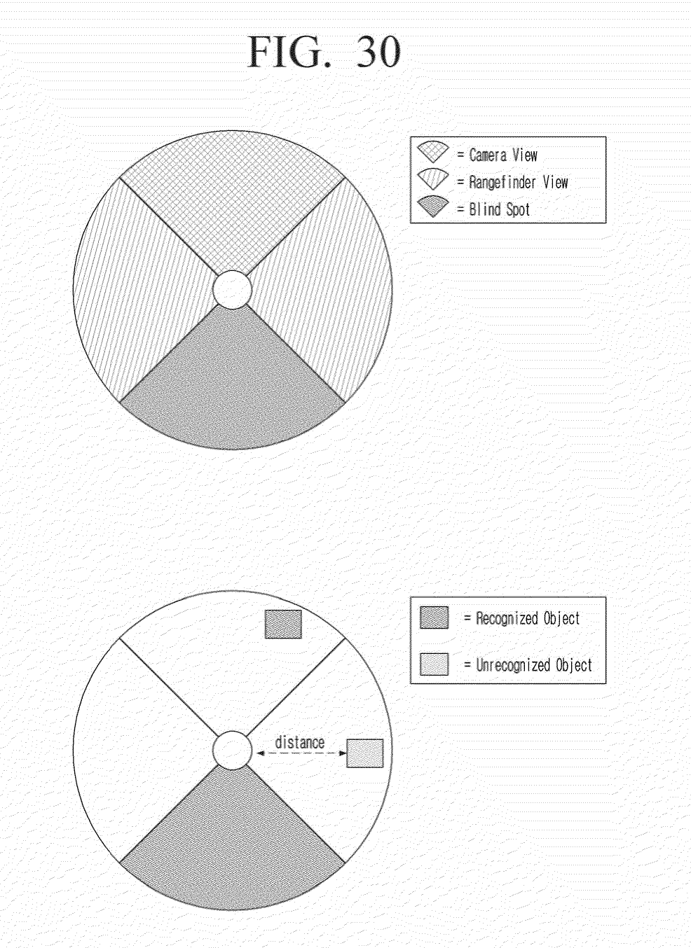

FIG. 30 is a diagram of the Field of View area used by the present system. To understand a user’s surrounding environmental condition, the present disclosure may use a camera and a rangefinder sensor. The present system can measure the distance between an object and the user using rangefinder sensors that are embedded in the left and right side of the glasses or VR devices. The system can only determine the object type when the object is located in front of the user, or within the camera view area. However, the system can still detect the presence of an object and its speed from the surrounding area based on the difference between objects’ position and the scanning time difference within the rangefinder view area.

Different people will have different preference for their most efficient walking speed. Visually impaired pedestrians, if allowed to set the speed when accompanied by a sighted guide, will prefer to walk at a speed that is close to that of sighted pedestrians. However, when walking independently they adopt a speed that is slower than their preferred walking speed. Based on several studies, it can be concluded that the average speed of a visually impaired person when walking is 96 meters/minute. There are several factors affecting the walking speed of a visually impaired person, such as age, leg length, body weight, and gender.

Walking without vision results in veering, an inability to maintain a straight path that has important consequences for visually impaired pedestrians. When walking an intended straight line, veering is the lateral deviation from that line. Veering by human pedestrians becomes evident when visual targeting cues are absent as in cases of blindness or severely reduced visibility. Based on some research, there is a potential for veering at a range of 4 meters when a person walks without vision. Thus, the relationship between speed and injury severity is particularly critical for vulnerable road users such as pedestrians. The higher the speed of a vehicle, the shorter the time a driver has to stop and avoid a crash. Based on the World report on road traffic injury prevention by WHO, if a moving object (vehicle) comes with a speed of at least 20 Km/h and hits the pedestrian, it can potentially cause an injury.

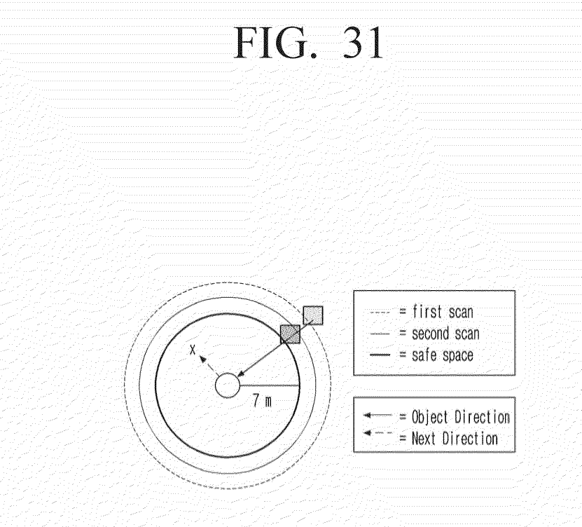

FIG. 31 is a diagram illustrating the safe space calculation. Combining all parameters, the veering potential, divided into two when the user walks with limited visibility, is 2 meters. The average walking speed of a visually impaired person is 1.6 meters/second (convert from 96 meters/minute). Thus, the action and reaction speed that the visually impaired takes is 2 meters / 1.6 meter/second = 1.25 seconds. To define the safe space for the visually impaired, the speed limit of the vehicle can be calculated, which is 5.55 meters/second (convert from 20 Km/h). Then, it is multiplied with the average speed of visually impaired reaction time, so the result is 5.55 × 1.25 seconds = 6.9375 meters, we round up to 7 meters. It can be assumed that the 7 meters distance is enough to anticipate if unexpected things suddenly come and are potentially dangerous for the user. Thus, the system will automatically set the safe space as 7 meters when it detects a potential dangerous situation.

From the safe space parameters defined above, a new space will be added as a layer for sensors to detect and track the moving object. Approximately 4 meters are added, or 57% from safe space, so the new layer will be 11 meters (7 m + 4 m). When the sensors detect the moving object at a range of 11 meters, the sensor will be tracking it and calculate the next movement of the object. When the speed is more than 20 km/h or 5.55 m/s, and the direction is entering the safe space parameter (7 m), the system will give an alert and a new direction for the user to avoid the object.

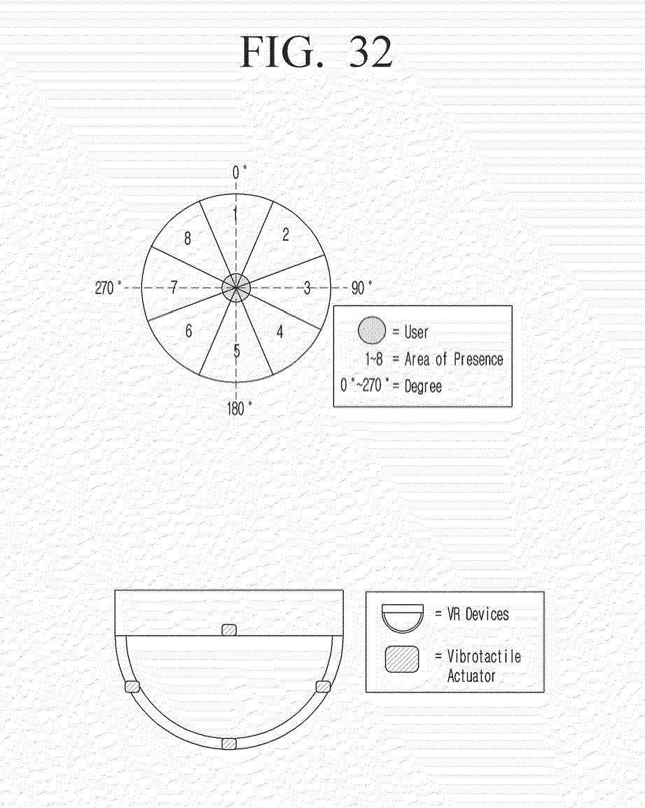

For VR devices, the alert will be a cue using a vibration based on the direction. The Vibrotactile Actuator will be used to give 360 degree sensing of the presence from the direction of possible danger object that needs to be avoided. It will be utilized to provide gentle stimulation which is placed in 4 places that is front, right, left, and back side of the VR, as can be seen on FIG. 32.

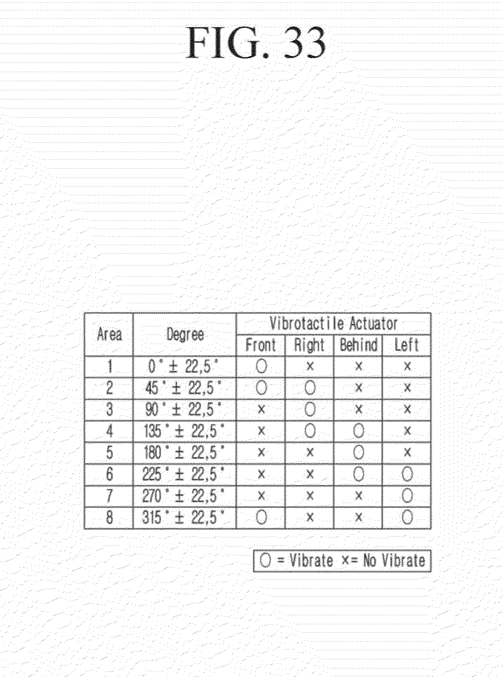

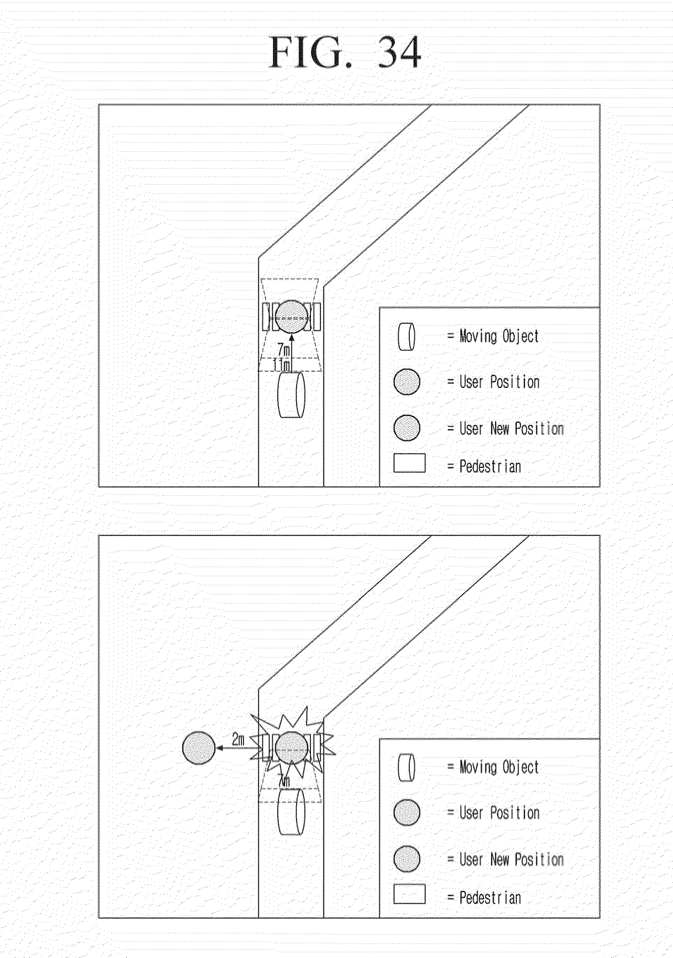

Based on these configuration systems can create eight combination area of the presence direction from the dangerous object. As can be seen on FIG. 33, the truth table for Vibrotactile Actuator can be categorized into 8 areas. After getting the information about a dangerous objects position, the new direction for the visually impaired user is generated from sensors using 3D sound output, with at least 2 meters (take half of the people’s potential veer) and angled at 90 degrees in the opposite from the object’s moving direction, as can be seen on FIG. 34.

All output from both the RTP-G and Danger Evasion modules will be the input for the 3DSP-G module. The system will use this input to decide the direction when generating 3D sound points that the user needs to follow. The trajectory path output will be provided based on two conditions. The trajectory path for guidance will be reconstructed by RTP-G module, and the trajectory path for sudden dangerous condition avoidance will be reconstructed by Danger Evasion module. The trajectory path provided by Danger Evasion module will have the highest priority to be executed first to the system.

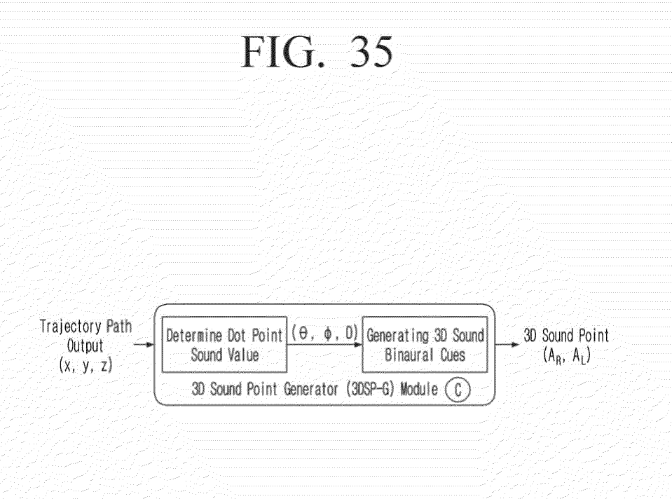

FIG. 35 is a block diagram of the 3DSP-G module, which comprises two main processes that run in sequence. The first process is to configured to determine the dot point sound value and position that will be heard by the user, based on the trajectory path that needs to be followed. Controlling human movement to follow the trajectory could be hard because of human perception error and the absence of direct control of the actuator.

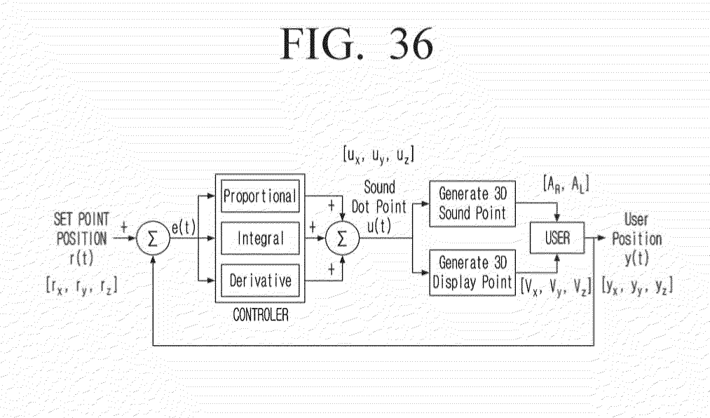

To achieve that, this system will use a Proportional-Integral-Derivative (PID) controller algorithm to define the 3D sound output position and value by comparing the user’s movement (position and orientation) and the desired position as the input for the controller scheme to automatically apply an accurate and responsive correction in a closed loop system, as can be seen on FIG. 36. The equation for this PID controller in-out close loop system is:

$$u \left(t\right) = {K}_{p} e \left(t\right) + {K}_{i} {\int }_{0}^{t} e \left({t}^{′}\right) d {t}^{′} + {K}_{d} \frac{d e \left(t\right)}{d t} ; e \left(t\right) = r \left(t\right) - y \left(t\right)$$

Where e(t) is the difference between a set point and the user’s current position and K is the constant for each representative for Proportional, Integral, and Derivative variable controller.

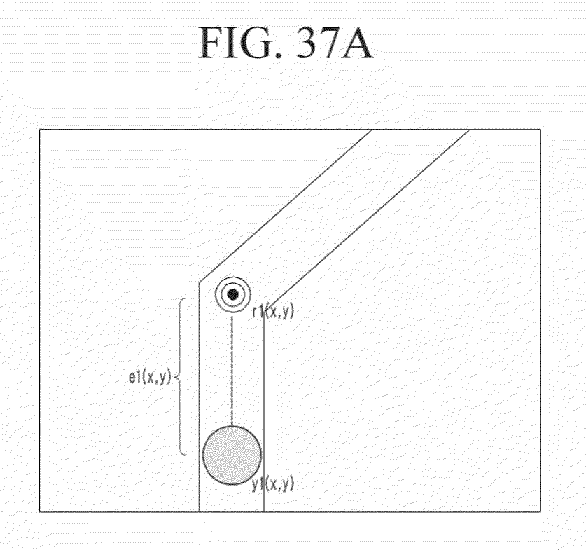

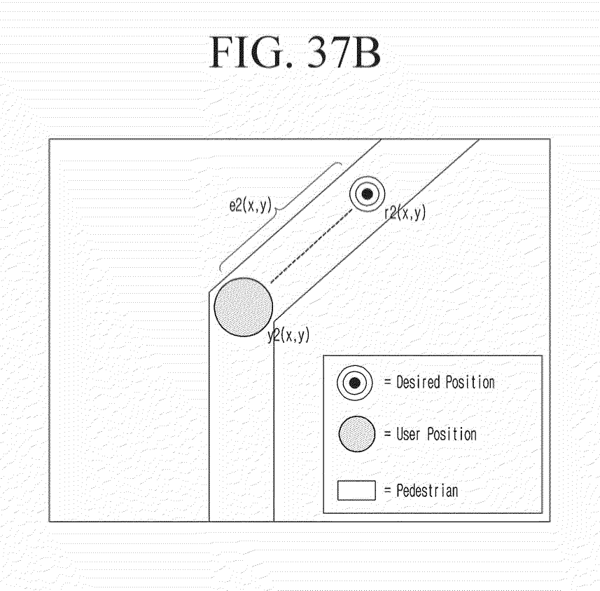

FIGS. 37A and 37B illustrate the relationship between the equation and the implementation of the PID controller calculation. Referring to FIG. 37A, at the t=1, the user has the next target position straight in front of him. At this time the difference value between set point position and user’s position for the x axis will be zero, so the controller will be resulting zero as well for x axis and the u(t) will only be affected by the y axis. But, Referring FIG. 37B, at t=2 the PID controller calculation will be affected by both axes. Since the e(t) will use multidimensional proportion, the angle of the wedge between each axis can be found and that is why the output of the PID controller u(t) will be quite specific to be fed to the next process for generating 3D sound binaural cues that need to be followed by the user.

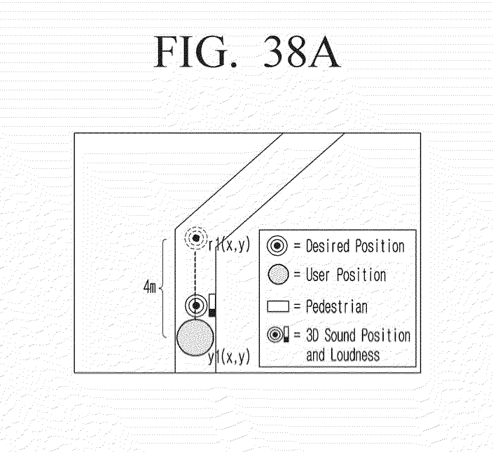

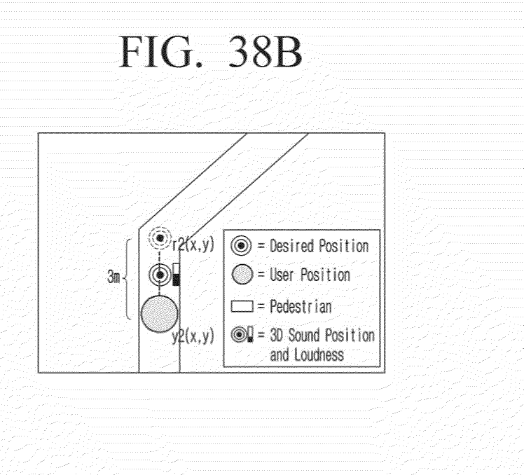

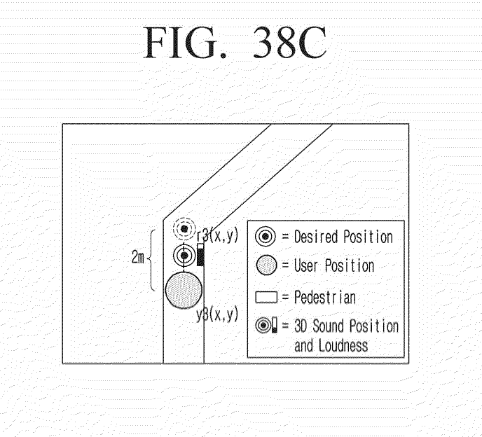

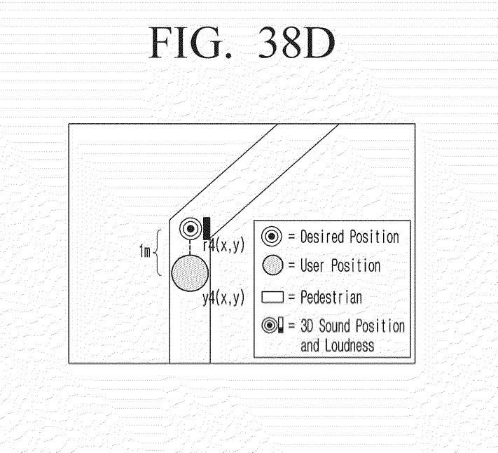

FIGS. 38A-38D illustrate the implementation of this process when guiding the user to every checkpoint in the usual and normal procedure. FIG. 38A shows that when the desired position is in a straight-line in front of the user, the user will hear the guidance sound in front of them. As the user is approaching the desired position, the system will gradually increase the loudness for the 3D sound until they reach the checkpoint, as illustrated in FIGS. 38B-38D. The process will be repeated again until the user arrives at the destination point.

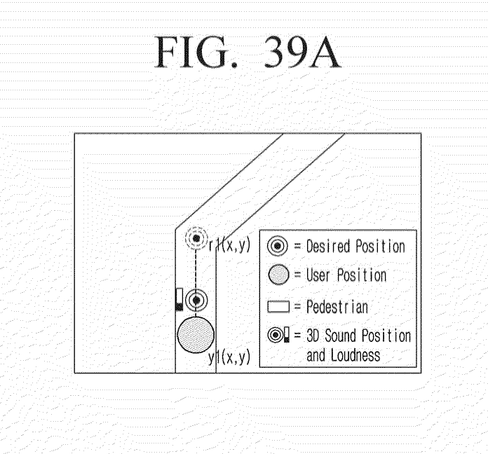

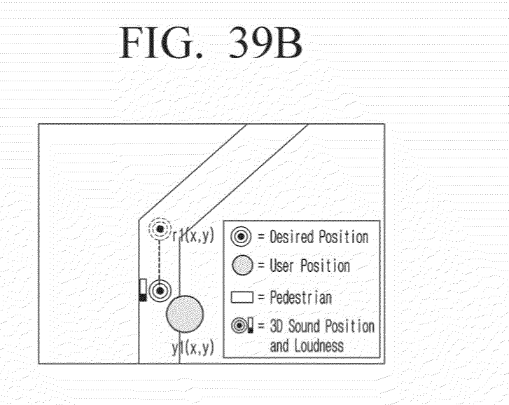

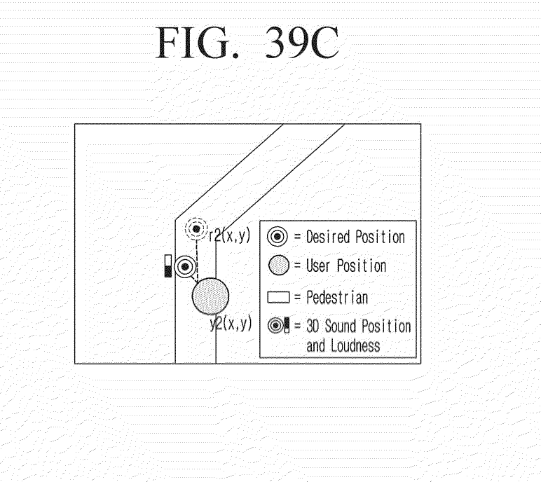

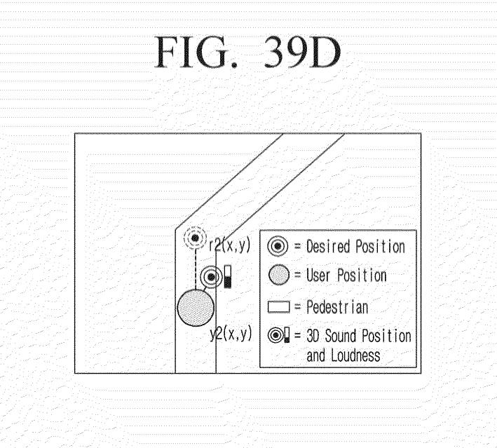

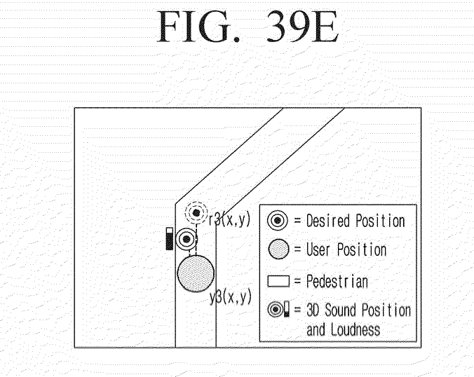

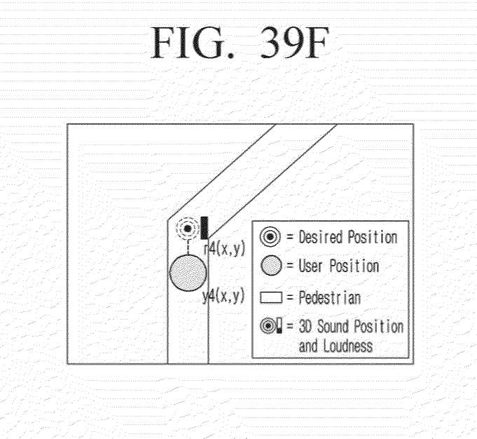

This process can also help the user to solve the user’s continuous error of perception. To make it easier for comparison, the same scenario of guidance will be used, but the user responds differently to the 3D sound point, as in the user is veering or not following the 3D sound point precisely. As can be seen on FIG. 39A-39-F, FIG. 39A shows when the 3D sound point at the starting point indicates the direction is in front of the user. FIG. 39B shows that the user does not respond to the sound by moving forward, but slightly to the right instead. FIG. 39C shows that the next 3D sound point will be on the left side of the trajectory path to compensate user’s movement errors. In FIG. 39D, the 3D sound point will change the position slightly to the right of the user when the user reaches the middle of the trajectory path. After that, the next sound point will be slightly to the left side of the user to keep the user to stay in the middle of the trajectory path as shown in FIG. 39E. When the user’s movement is steady along the trajectory path to the desired position, the 3D sound point position will be straight forward to the user again as shown in FIG. 39F. By using this close loop controlled system, the system will always keep the user’s position in the desired position and can guide the user to walk safely.

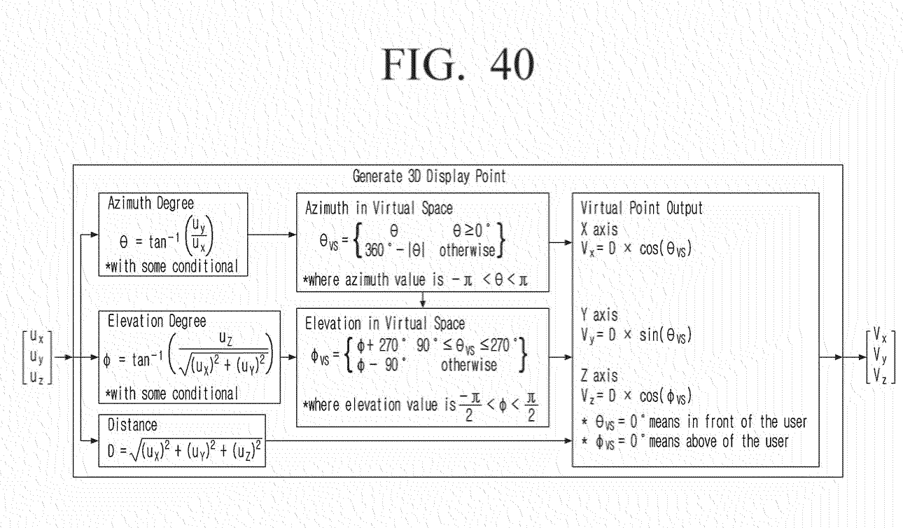

FIG. 40 describes the process for generating the 3D display point. For VR devices, after the PID controller gives the output, the second process is to generate 3D Display Point to be seen by the user from the VR devices. To create the 3D Display Point, the system needs to calculate the virtual space coordinate and there may be three main processes involved. First, the output from the PID controller will be converted as a point in polar diagram under the user base. Then, the value will be converted into 360 degrees which will be used in Virtual Space. Third, the system will calculate the virtual point output that will be implemented to a virtual map that comprises a x axis, y axis, and z axis point.

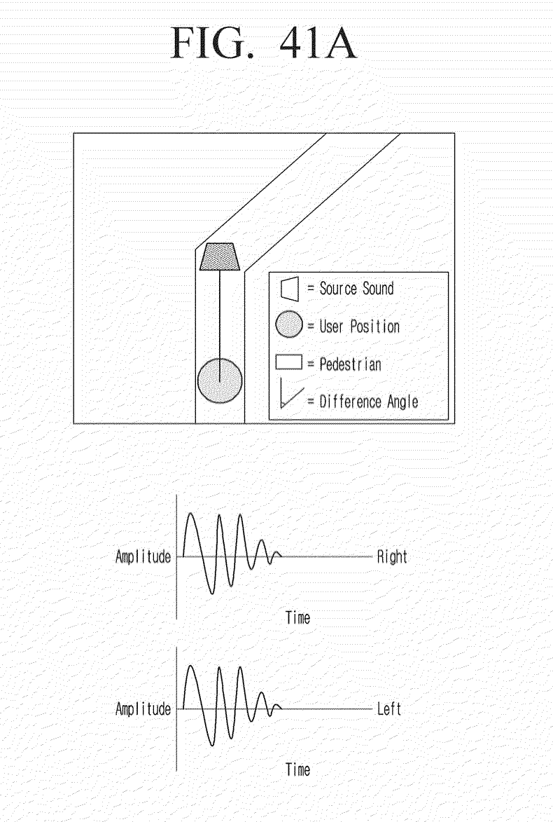

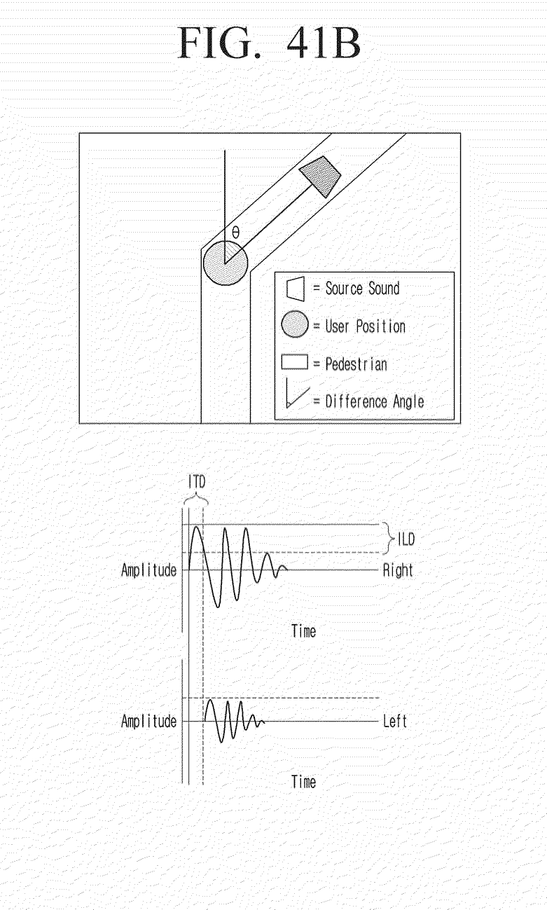

FIGS. 41A and 41B illustrate ITD and ILD for sound location. For all target devices, after the PID controller gives the output, the next process is to generate 3D sound for binaural cues to be heard by the user from the headset devices. To create 3D sound effect using stereo output, the system will manipulate the ILD and ITD from the 3D adaptive sound point. FIG. 41A shows that there is no difference between the starting time of sound and the amplitude difference in both left and right ear. This is because the artificial source sound is directly in front of the user and the angle difference is zero. However, there is a presence of both ITD and ILD on FIG. 41B. The ITD is measured based on the sound arrival time difference between two ears, which can be represented by the distance between two vertical lines. The ILD is measured based on the sound intensity’s difference between two ears which can be represented by the distance between two horizontal lines where, both ITD and ILD, the straight line is for right ear and the dashed line for the left ear. From the graph, the amplitude sound from the right ear is higher than the left ear, and the delay of sound arrival time is occurring on left ear FIG. 41B.

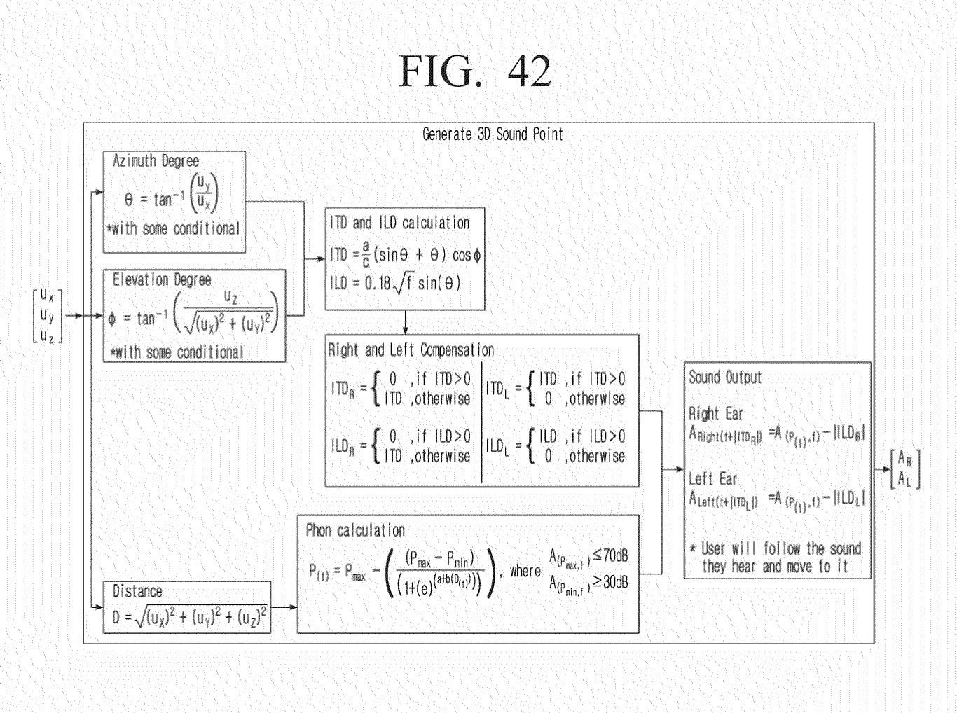

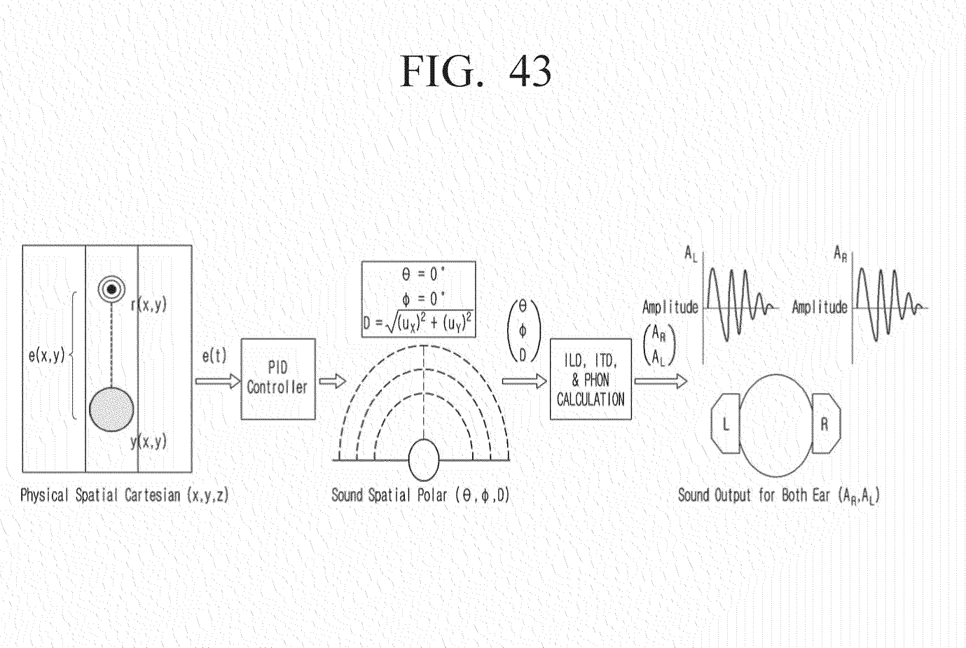

FIG. 42 and FIG. 43 describe the calculation and the process for generating 3D sound point. To complement the 3D adaptive sound point, the system needs to update the equation that controls the sound output from headset to both human ears based on ITD and ILD calculation. In an embodiment, the present disclosure uses the ITD equation from Savioja, L, which considers the value of head radius (a), the speed of sound (c), and covers the angle from horizontal plane (azimuth) and the angle from vertical plane (elevation) from the source sound that is to compensate for the decay of the time arrival of the sound.

$$I T D = \frac{a}{c} \left(s i n θ + θ\right) c o s φ$$

$$θ = a z i m u t h a n g l e \left[R a d\right] \left(- π < θ < π\right)$$

$$φ = e l e v a t i o n a n g l e \left[R a d\right] \left(\frac{- π}{2} < φ < \frac{π}{2}\right)$$

Based on above equations, the compensation of time arrival of sound for both ITD on right and left ear can be determined.

$$I T {D}_{R} = \left\{\begin{matrix}0 & , i f I T D > 0 \\ I T D & , o t h e r w i s e\end{matrix}\right) I T {D}_{L} = \left\{\begin{matrix}I T D & , i f I T D > 0 \\ 0 & , o t h e r w i s e\end{matrix}\right)$$

For the ILD, In an embodiment, the present disclosure uses the equation from Van Opstal, J, which considers the value of frequency and the angle of horizontal plane (azimuth) from the source sound to compensate for the pressure level difference of the sound.

$$I L D = 0.18 \sqrt{f} s i n \left(θ\right)$$

$$θ = a z i m u t h a n g l e \left[R a d\right] \left(- π < θ < π\right)$$

Based on the equation, the compensation of sound pressure difference level of sound for both ILD on right and left ear can be determined.

$$I L {D}_{R} = \left\{\begin{matrix}0 & , i f I L D > 0 \\ I L D & , o t h e r w i s e\end{matrix}\right) I L {D}_{L} = \left\{\begin{matrix}I L D & , i f I L D > 0 \\ 0 & , o t h e r w i s e\end{matrix}\right)$$

In an embodiment, the adaptive 3D sound point for the binaural cues is calculated with this formula.

$${P}_{\left(t\right)} = {P}_{m a x} - \left(\frac{\left({P}_{m a x} - {P}_{m i n}\right)}{\left(1 + {\left(e\right)}^{\left(a + b \left({X}_{t a r g e t \left(t\right)} - {X}_{u s e r \left(t\right)}\right)\right)}\right)}\right) , w h e r e {}_{{A}_{\left({P}_{m i n} , f\right)} \geq 30 d B}^{{A}_{\left({P}_{m a x} , f\right)} \leq 70 d B}$$

$${A}_{R i g h t \left(t + \left|I T {D}_{R}\right|\right)} = {A}_{\left({P}_{\left(t\right)} , f\right)} - \left|I L {D}_{R}\right|$$

$${A}_{L e f t \left(t + \left|I T {D}_{L}\right|\right)} = {A}_{\left({P}_{\left(t\right)} , f\right)} - \left|I L {D}_{L}\right|$$

Where A_{(P₍ₜ₎,f)} is the function for getting sound pressure level in decibel based on phon value and frequency value, A_{Right} is the amplitude of sound output for right ear, and A_{Left} is the amplitude of sound output for the left ear.

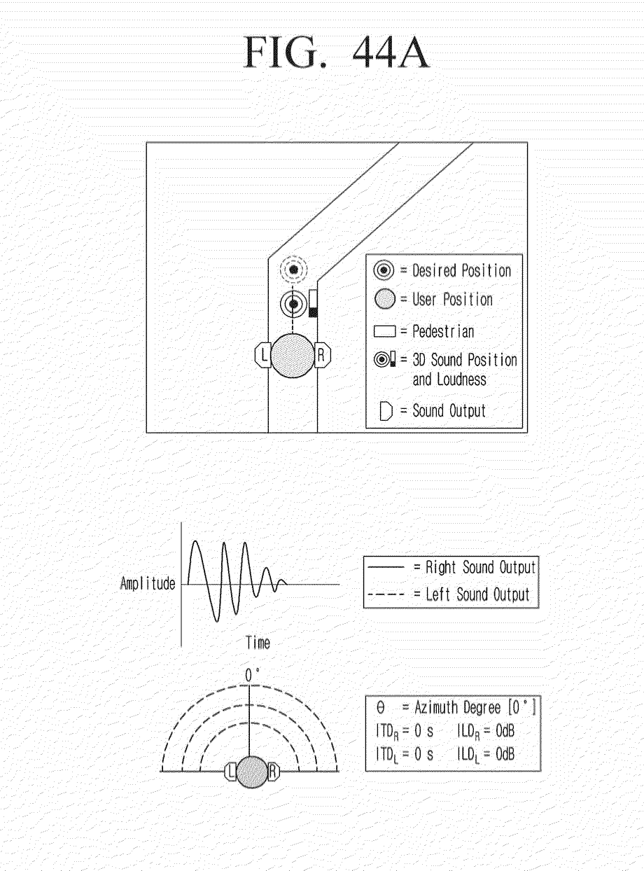

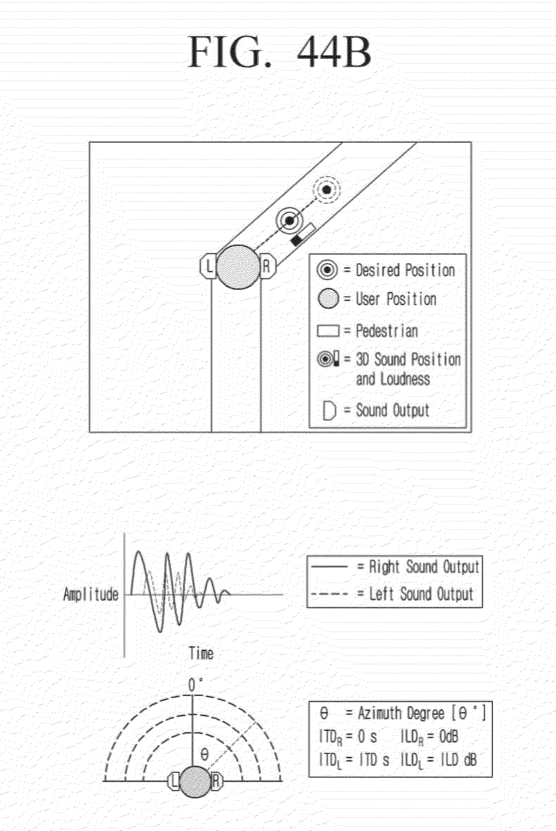

FIGS. 44A and 44B describe the implementation of 3D sound binaural cues using adaptive sound. The output from the RTP-G module and the Danger Evasion module will be the desired position that the user needs to reach in Cartesian coordinates. Then, it will be converted to 3D sound point position and loudness in Polar coordinates. The sound output will be determined by using the adaptive sound point calculation above that considers the artificial ILD and ITD factors to create 3D sound effect to allow a human to localize the sound. FIG. 44A shows the azimuth degree as zero and the sound output for the right and left ear is same with zero to compensate ITD and ILD for both sides. However, in FIG. 44B, the azimuth degree is not zero. Thus, the sound output for the left ear will be compensated and creating the effect of sound source position that can be understood by natural human sound location.

By configuring the sound output for both the left and right side of the headset properly, artificial 3D sound point location can be created, which is very specific as the desired position that can be heard and followed by the user for guidance. The more precise the 3D sound position can be created, the better the visually impaired user can follow the guidance sound. The user will be able to move from position to position by following the sound for every checkpoint, and the whole process will always continue looping until the user reaches the destination position. It will be helpful for them to achieve their full potential for walking safely and independently throughout their daily life.

What is claimed is:

1. A system for assisting a visually impaired user to navigate a physical environment comprising:
a camera;
a range sensor;
a microphone;
a sound output device;
a memory configured to store at least one instruction; and
a processor configured to execute the at least one instruction to:
receive an information on the user’s then current position from one or more of the camera, the range sensor, and the microphone,
receive an information on a destination from the microphone,
generate a first path from the user’s starting position to the destination, and
based on the first path, determine in real-time at least one 3D sound point value and position and provide an output to the sound output device,
wherein the output to the sound output device comprises 3D a directional sound configured to provide sensory prompts to guide the user as the user moves along the first path.

2. The system of claim 1, wherein the processor is further configured to execute the at least one instruction to:
receive an information on the location of an obstacle on the first path from one or more of the camera and the range sensor, and based on the identification of the obstacle on the first path, to alter the first path to avoid the obstacle.

3. The system of claim 2, wherein the processor is further configured to execute the at least one instruction to:
receive an information on a moving object within a first range of the user from one or more of the camera and the range finder,
determine a probability of the moving object posing a safety risk to the user, and
based on the probability of the moving object posing a safety risk to the user exceeding a threshold, generating a warning signal to the user through the sound output device.

4. The system of claim 1, wherein the processor is further configured to execute the at least one instruction to:
identify at least one checkpoint along the first path, wherein the at least one checkpoint is located between the user’s then current position and the destination,
generate a first checkpoint trajectory between the user’s then current position and the at least one checkpoint, and
based on the first checkpoint trajectory, determine in real-time at least one 3D sound point value and position and provide a first checkpoint trajectory output to the sound output device,
wherein the first checkpoint trajectory output to the sound output device comprises 3D directional sound configured to provide sensory prompts to guide the user as the user moves along the first path toward the first checkpoint.

5. The system of claim 1 further comprising a GPS receiver, wherein the information on the user’s then current position is received from one or more of the camera, the range sensor, the microphone, and the GPS receiver.

6. The system of claim 5, wherein the processor is further configured to execute the at least one instruction to:
receive a real-time update information on the user’s then current position as the user moves along the first path, and
provide the real-time update information to a Proportional-Integral-Derivative (PID) controller, wherein the PID controller is configured to determine whether the user has deviated from the first path, and based on a determination that the user has deviated from the first path, to determine in real-time at least one corrective 3D sound point value and position and provide a corrective output to the sound output device,
wherein the corrective output to the sound output device comprises 3D directional sound configured to provide sensory prompts to guide the user in a direction that will reduce the difference between the user’s then current position and the first path.

7. A method of assisting a visually impaired user to navigate a physical environment comprising, the method performed by at least one processor and comprising:
receiving an information on the user’s then current position from one or more of a camera, a range sensor, and a microphone;
receiving an information on a destination from a microphone;
generating a first path from the user’s starting position to the destination; and
based on the first path, determining in real-time at least one 3D sound point value and position and providing an output to the sound output device,
wherein the output to the sound output device comprises 3D a directional sound configured to provide sensory prompts to guide the user as the user moves along the first path.

8. The method of claim 7, further comprising:
receiving an information on the location of an obstacle on the first path from one or more of the camera and the range sensor, and based on the identification of the obstacle on the first path, altering the first path to avoid the obstacle.

9. The system of claim 8, further comprising:
receiving an information on a moving object within a first range of the user from one or more of the camera and the range finder;
determining a probability of the moving object posing a safety risk to the user; and
based on the probability of the moving object posing a safety risk to the user exceeding a threshold, generating a warning signal to the user through the sound output device.

10. The method of claim 7, further comprising:
identifying at least one checkpoint along the first path, wherein the at least one checkpoint is located between the user’s then current position and the destination,
generating a first checkpoint trajectory between the user’s then current position and the at least one checkpoint; and
based on the first checkpoint trajectory, determining in real-time at least one 3D sound point value and position and providing a first checkpoint trajectory output to the sound output device,
wherein the first checkpoint trajectory output to the sound output device comprises 3D directional sound configured to provide sensory prompts to guide the user as the user moves along the first path toward the first checkpoint.

11. The method of claim 7, wherein the information on the user’s then current position is received from one or more of the camera, the range sensor, the microphone, and a GPS receiver.

12. The method of claim 11, further comprising:
receiving a real-time update information on the user’s then current position as the user moves along the first path; and
providing the real-time update information to a Proportional-Integral-Derivative (PID) controller, wherein the PID controller is configured to determine whether the user has deviated from the first path, and based on a determination that the user has deviated from the first path, determining in real-time at least one corrective 3D sound point value and position and providing a corrective output to the sound output device,
wherein the corrective output to the sound output device comprises 3D directional sound configured to provide sensory prompts to guide the user in a direction that will reduce the difference between the user’s then current position and the first path.

13. A non-transitory computer readable medium having instructions stored therein, which are executable by a processor to perform a method of assisting a visually impaired user to navigate a physical environment, the method comprising:
receiving an information on the user’s then current position from one or more of a camera, a range sensor, and a microphone;
receiving an information on a destination from a microphone;
generating a first path from the user’s starting position to the destination; and
based on the first path, determining in real-time at least one 3D sound point value and position and providing an output to the sound output device,
wherein the output to the sound output device comprises 3D a directional sound configured to provide sensory prompts to guide the user as the user moves along the first path.

14. The non-transitory computer readable medium of claim 13, wherein the method further comprises:
receiving an information on the location of an obstacle on the first path from one or more of the camera and the range sensor, and based on the identification of the obstacle on the first path, altering the first path to avoid the obstacle.

15. The non-transitory computer readable medium of claim 14, wherein the method further comprises:
receiving an information on a moving object within a first range of the user from one or more of the camera and the range finder;
determining a probability of the moving object posing a safety risk to the user; and
based on the probability of the moving object posing a safety risk to the user exceeding a threshold, generating a warning signal to the user through the sound output device.

16. The non-transitory computer readable medium of claim 13, wherein the method further comprises:
identifying at least one checkpoint along the first path, wherein the at least one checkpoint is located between the user’s then current position and the destination,
generating a first checkpoint trajectory between the user’s then current position and the at least one checkpoint; and
based on the first checkpoint trajectory, determining in real-time at least one 3D sound point value and position and providing a first checkpoint trajectory output to the sound output device,
wherein the first checkpoint trajectory output to the sound output device comprises 3D directional sound configured to provide sensory prompts to guide the user as the user moves along the first path toward the first checkpoint.

17. The non-transitory computer readable medium of claim 13, wherein the information on the user’s then current position is received from one or more of the camera, the range sensor, the microphone, and a GPS receiver.

18. The non-transitory computer readable medium of claim 17, wherein the method further comprises:
receiving a real-time update information on the user’s then current position as the user moves along the first path; and
providing the real-time update information to a Proportional-Integral-Derivative (PID) controller, wherein the PID controller is configured to determine whether the user has deviated from the first path, and based on a determination that the user has deviated from the first path, determining in real-time at least one corrective 3D sound point value and position and providing a corrective output to the sound output device,
wherein the corrective output to the sound output device comprises 3D directional sound configured to provide sensory prompts to guide the user in a direction that will reduce the difference between the user’s then current position and the first path.
